(19) United States
(12) Patent Application Publication
(10) Pub. No.: US 2026/0113391 A1
(43) Pub. Date: Apr. 23, 2026

(54) METHODS AND APPARATUS FOR A UNIFIED STREAM FORMAT

(71) Applicant: DIRECTV, LLC, El Segundo, CA (US)

(72) Inventors: Horia-Mihai Popa, Iasi (RO); Reza Pezeshki, Chevy Chase, MD (US); Wassim Daccache, Ellicott City, MD (US); Drew Truland Chen, Clarksburg, MD (US); Matei Dediu, Bucharest (RO); Ionut-Andrei Luncanu, Iasi (RO); Richard Bradley Tatem, Middletown, MD (US)

(21) Appl. No.: 19/249,708

(22) Filed: Jun. 25, 2025

Related U.S. Application Data
(60) Provisional application No. 63/710,850, filed on Oct. 23, 2024.

(51) Int. Cl. H04L 69/22; H04L 12/18

(52) U.S. Cl. CPC H04L 69/22; H04L 12/1886

(57) ABSTRACT

Systems, apparatus, articles of manufacture, and methods are disclosed. An example apparatus includes programmable circuitry within a network to: obtain first packets from a first device within the network, the first packets structured according to a formatting protocol, the first device and the apparatus connected to one another with a wiring topology that includes the Internet Protocol, a given packet within the first packets including a header section and a data section, form second packets that are also structured according to the formatting protocol, the second packets having the same data sections but different header sections than the first packets, and transmit the second packets to a second device within the network, the second device and the apparatus connected to one another using a wiring topology that does not include the Internet Protocol.

### RELATED APPLICATION

This patent claims the benefit of U.S. Provisional Patent Application No. 63/710,850 , which was filed on Oct. 23, 2024. U.S. Provisional Patent Application No. 63/710,850 is hereby incorporated by reference in its entirety. Priority to U.S. Provisional Patent Application No. 63/710,850 is hereby claimed.

### FIELD OF THE DISCLOSURE

This disclosure relates generally to media streams and, more particularly, to methods and apparatus for a unified stream format.

### BACKGROUND

In recent years, techniques for the distribution of media streams have evolved to support various wiring topologies. Such wiring topologies include both wireless and wired transmission mediums and a variety of communication standards such as Ethernet, Wireless Fidelity (Wi-Fi), coaxial cables (COAX), radio frequency architectures such as satellite, radio via over-the-air (OTA), etc.

### BRIEF DESCRIPTION OF THE DRAWINGS

FIG. 1 is a block diagram that includes various streaming environments.

FIG. 2 is a block diagram of a streaming environment of FIG. 1.

FIG. 3 is a block diagram of an example implementation of the media manager circuitry (MMC) and a client device of FIG. 2.

FIGS. 4A and 4B are illustrative examples of devices implementing the DUSF protocol.

FIG. 5 shows illustrative examples of the header section and data section of the DirecTV® Unified Stream Format (DUSF) protocol described herein.

FIG. 6 is a table describing example values for the TYPE field at byte index 0 of the header section of FIG. 5.

FIGS. 7A and 7B are an example code snippet and table describing the DATA field of FIG. 5 for an Initialization Packet Type (IPT).

FIG. 8 is an example table describing the DATA field of FIG. 5 for a Source Metadata Packet Type (SMPT).

FIG. 9 is a flowchart representative of example machine-readable instructions and/or example operations that may be executed, instantiated, and/or performed by example programmable circuitry to implement the orchestrator circuitry of FIG. 2.

FIG. 10 is a flowchart representative of example machine-readable instructions and/or example operations that may be executed, instantiated, and/or performed by example programmable circuitry to form a DUSF packet based on a chunk as described above in connection with FIG. 9.

FIG. 11 is a flowchart representative of example machine-readable instructions and/or example operations that may be executed, instantiated, and/or performed by example programmable circuitry to implement a device that receives a DUSF packet.

FIG. 12 is a table that compares the DUSF protocol to known media delivery protocols.

FIG. 13 is a block diagram of an example processing platform including programmable circuitry structured to execute, instantiate, and/or perform the example machine-readable instructions and/or perform the example operations of FIGS. 9-11 to implement the Media Manager Circuits (MMCs) 202 and/or the client devices 204 of FIG. 3.

FIG. 14 is a block diagram of an example implementation of the programmable circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine-readable instructions of FIGS. 9-11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Updating wiring topology can be a very expensive and time-consuming effort, particularly in venues in with large video distribution backbones. As a result, some streaming environments may employ newer wiring topologies when expanding their network and simultaneously rely on legacy wiring topologies for older, pre-existing portions of their network. As used above and herein, a streaming environment refers to a private network that a) includes a large number of devices requesting media and b) is controlled by a management organization. Such streaming environments may include, but are not limited to, hotels, hospitals, malls, restaurants, sports bars, other commercial spaces, multiple dwelling units (MDUs), residential dwellings, etc.

As used herein, the term “wiring topology” refers to both the physical medium across which data is transmitted and the one or more communication protocols that are used during the transmission. In some examples, the terms “physical medium” and “transmission medium” may be used interchangeably.

Conventionally, delivery of media content to multiple devices utilizes a unicast architecture in which a content delivery network supports n different transmissions of the same media from a content provider to n different devices. In some examples, the n devices that receive copies of the same media belong to a local network of streaming-capable devices within a shared environment.

In some examples, streaming environments that include legacy wiring topologies struggle to support efficient delivery of over the top (OTT) media. As used herein, OTT media refers to media that is transmitted and/or received over the Internet. If such environments utilize a unicast content delivery network, a sufficiently large number of devices (n) requesting media at the same time can result in the need to transmit data that exceeds (or constitutes a disproportionate amount of) the total network traffic bandwidth available in the environment. As a result, one or more media playback sessions in the environment may experience a decrease in quality due to buffering, disconnections, etc. Additionally or alternatively, the large request for data from the n devices requesting media may cause other devices (e.g., phones, tablets, laptops) using the environment's local network to experience disconnections or other latencies. In some examples, a device requesting media is referred to as a client device.

Multicast content delivery systems may be utilized to decrease total network traffic and improve user experiences. In a multicast architecture, a content delivery network enables one transmission of a media stream from a content provider to a primary device (e.g., a server) located within the environment. The primary device then transmits n copies of the media stream to the n devices within the environment requesting the same media at approximately the same time. Using multicast, the number of transmissions (e.g., channels of communication dedicated to a particular media stream) between the environment and the content delivery network is reduced from n to 1, thereby decreasing the total network traffic and improving user experiences.

As used above and herein, a media stream refers to data used to enable playback of a piece of media (e.g., a movie, a television show, a television channel, a live stream, etc.). The media stream may be provided to a playback device in any suitable format including but not limited to linear television channels and Video on Demand (VOD) services. The VOD services may follow any business model, including but not limited to Transactional Video on Demand (TVOD, also known as pay-per-view (PPV)), Subscription Video on Demand (SVOD), Advertising Video on Demand (AVOD), etc.

While multicast networks are generally more efficient than unicast networks, receiving a multicast stream requires the use of communication protocols that are not supported by some client devices. In many examples, a client device cannot support the multicast communication protocol because it uses a legacy wiring protocol. Additionally, different client devices may provide support for different types of multicast communication protocols. Such protocols include but are not limited to User Datagram Protocol (UDP) and Quadrature Amplitude Modulation (QAM). Thus, a streaming environment may include some client devices that only support a unicast transmission, some client devices that only support multicast transmissions via UDP, and some client devices that only support multicast transmissions via QAM. Such environments may still experience decreases in streaming quality due to the number of devices and network bandwidth limitations described above.

Example methods, apparatus, and systems described herein implement a DirecTV® Unified Stream Format (DUSF) protocol that can be used in widely different wiring topologies (including but not limited to Wi-Fi, COAX, RF, Ethernet, etc.) over a variety of protocols (including but not limited to Transport Control Protocol (TCP), UDP, QAM, Digital Video Broadcasting-Terrestrial (DVB-T), etc.). The example DUSF protocol therefore creates a layer that bridges the gap between different physical mediums and video distribution technologies (e.g., different wiring topologies) to improve video quality over known techniques. For example, the DUSF protocol is infrastructure agnostic (and therefore not dependent on a specific wiring topology) but still achieves high efficiency OTT video delivery. The DUSF protocol also lowers the amount of traffic requested from Content Delivery Networks (CDNs) to serve each individual request by locally multicasting one instance of a media stream. Furthermore, the DUSF protocol allows video delivery to be distributed from a centralized headend to a combination of multiple different endpoints, thereby enabling centralized content delivery management and scalability. In some examples, the DUSF protocol may be referred to as a formatting protocol.

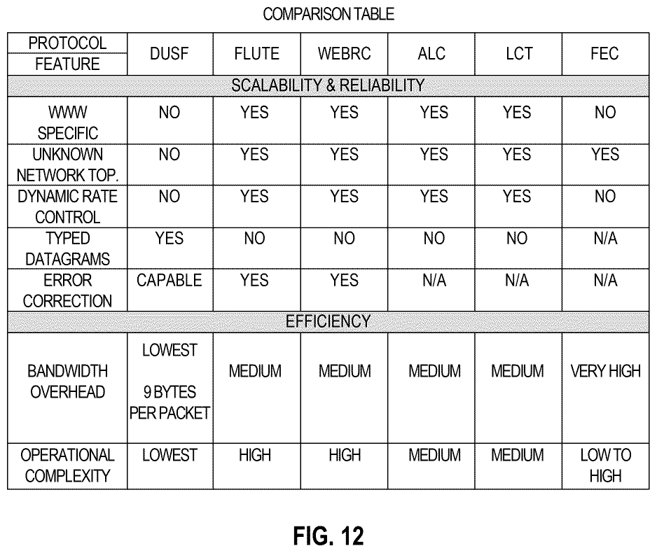

Known protocols to deliver media are designed to be generic. As a result, such protocols cannot presume there is a management organization that instructs client devices within a network how to communicate with one another. Known protocols are therefore designed around a specific wiring topology to ensure all devices that use said wiring topology can communicate with one another. However, such an approach may cause inefficiencies and poor media playback quality in streaming environments with a mixed or unknown wiring topology as described above. In contrast, the example DUSF protocol described herein is designed for private networks that are controlled by management organizations. As a result, the DUSF protocol can increase efficiency and improve media playback quality in streaming environments even when the environment has a mixed or unknown wiring topology. A comparison of the example DUSF protocol to various known media delivery protocols is described further in connection with FIG. 12.

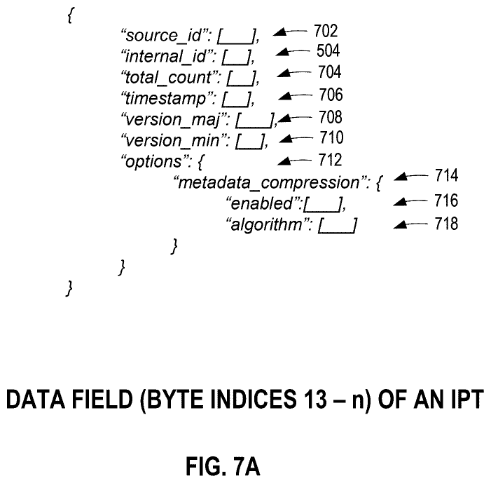

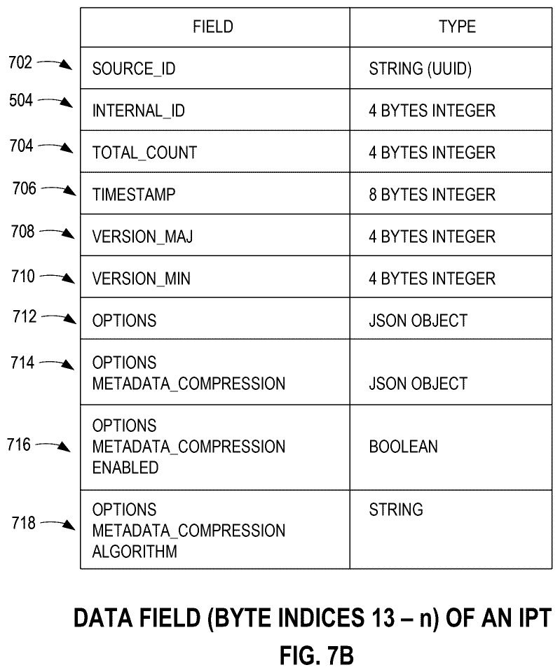

The DUSF protocol is designed to repacketize a stream to alter the transport format when transferring data and recreate the original data at the receiving end without content decryption or transcoding. For example, when distributing OTT video streaming data (audio/video) in a large local video distribution, it is hard to efficiently distribute the content locally due to the nature of OTT video protocols being point to point. DUSF allows devices to receive unicast packets like HTTP video streams and repacketize the contents to any kind of one-to-many transmission method. Such transmissions are described further in connection with FIGS. 7A and 7B. DUSF can therefore be utilized to convert information multiple times, suitable for various wiring topologies, between a source device and a destination device.

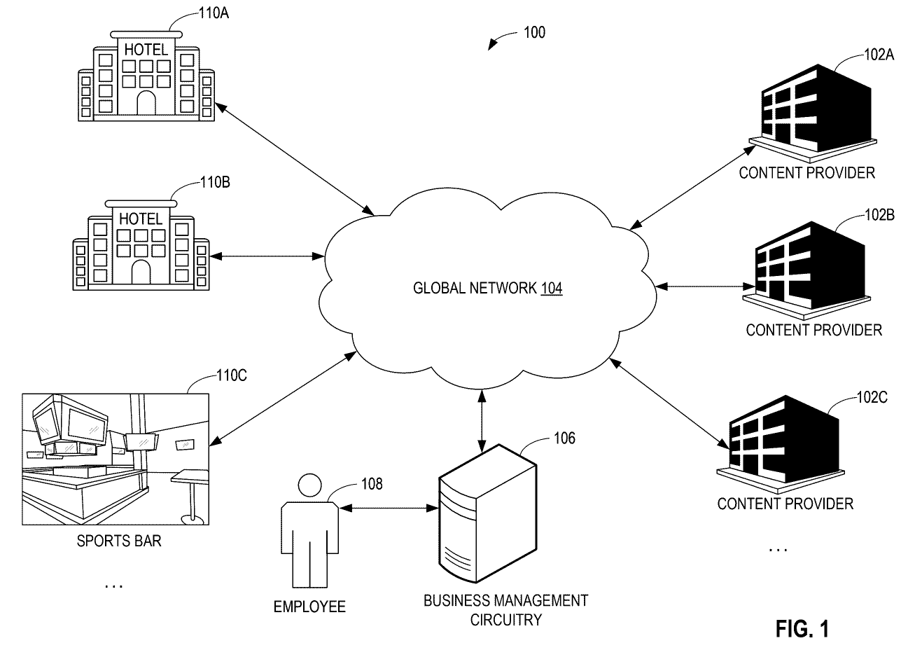

FIG. 1 is an illustrative example of media streaming. The example of FIG. 1 shows a system 100 that includes content providers 102A, 102B, 102C, . . . (collectively referred to as content providers 102), a global network 104, business management circuitry 106, a user 108, and streaming environments 110A, 110B, 110C, . . . (collectively referred to as streaming environments 110).

The content providers 102 provide data that forms various media streams. A media stream may be formatted as a linear television channel, a live stream, a video on demand (VoD) or streaming platforms, etc. The media stream may correspond to any type of content, including news, sports, television shows, movies, etc. While the example of FIG. 1 shows three content providers 102A, 102B, 102C, a given device may in practice request media from any number of content providers 102.

A given content provider 102A may host one or more compute devices (e.g., servers) that receive requests for content and provide a corresponding media stream via the global network 104. In some examples, the OTT media provided by the content providers 102 is Digital Rights Management (DRM) HLS content that can only be transmitted using HTTP.

The global network 104 enables communication between one or more of the content providers 102, the business management circuitry 106, and the streaming environments 110. In some examples, the data exchange includes HTTP requests and HTTP streams as described above.

The global network 104 may be implemented by any number of internal nodes using any number of transmission mediums and any number of communication topologies. In the illustrative example of FIG. 1, the global network 104 is the Internet. However, the global network 104 may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events.

The streaming environments 110 refer to any environments in which a plurality of client devices request media. In examples described herein, the streaming environments 110A and 110B are hotels and the streaming environment 110C is a sports bar. In other examples, one or more of the streaming environments 110 may be a mall, a household with multiple televisions, other commercial or residential dwellings, etc. The various streaming environments 110 may have different numbers of client devices, different client device configurations, and/or different network infrastructure from one another. The term ‘network infrastructure’ as used above may include, but is not limited to, the amount and age of wiring within the building, whether the building supports COAX, Ethernet, Wi-Fi, a combination thereof, or other Internet communication protocols, the amount of bandwidth that can be simultaneously consumed by client devices within the building, etc.

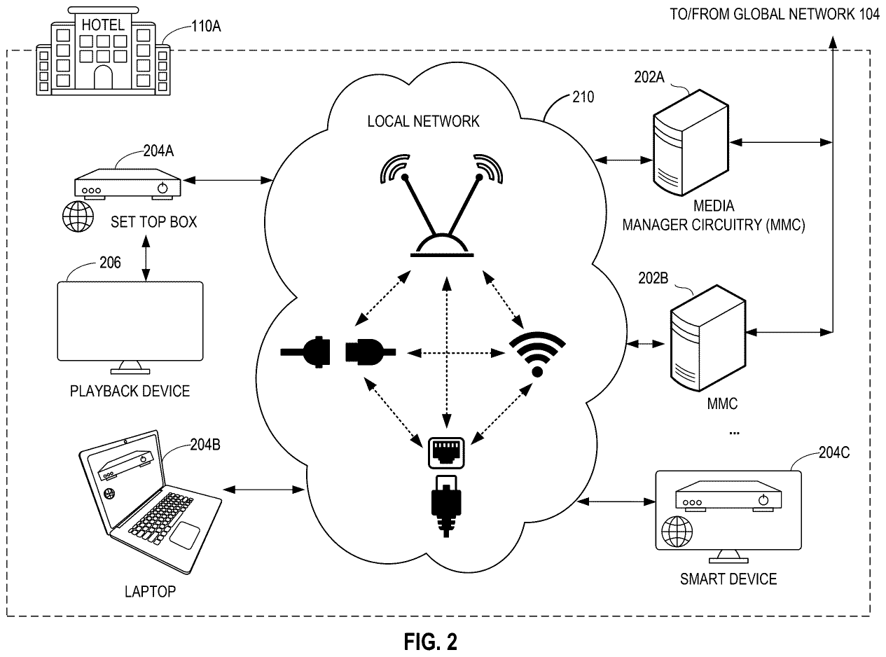

Media streaming within a given streaming environment 110A is controlled by media manager circuitry (MMC). An MMC uses instructions from the business management circuitry 106 to improve streaming quality and local network efficiency for client devices within the streaming environment 110A. The streaming environments 110, MMCs, and client devices are described further in connection with FIG. 2A.

In the examples described herein, the streaming environments 110A and 110B are part of a chain of hotels that are managed by an organization, e.g., a business. The operations performed by the MMC in the streaming environment 110A are different than those performed by the MMC in the streaming environment 110B because of the differences between the two networks described above. Furthermore, the management organization in charge of the hotel chain may have business reasons for controlling the local network within the streaming environment 110A differently from the local network within the streaming environment 110B. For example, a hotel that primarily serves business guests on travel may have different streaming requirements than a hotel that primarily serves families on vacation.

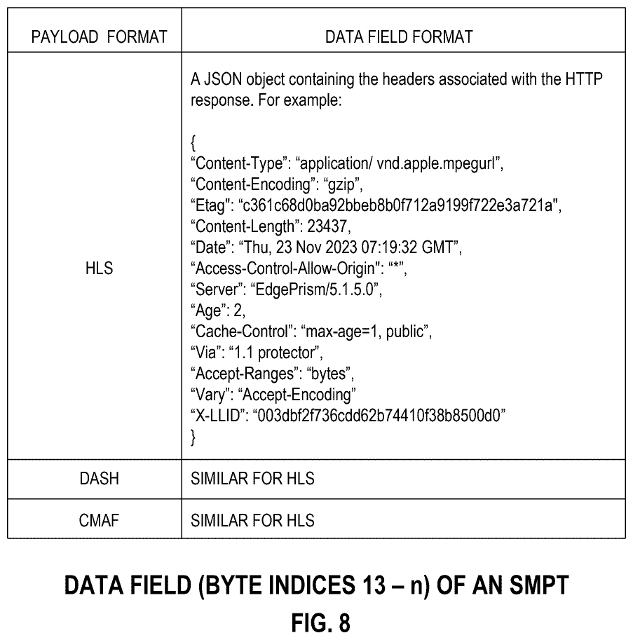

The business management circuitry 106 provides instructions, via the global network 104, to each of the MMCs within the respective streaming environments 110. Accordingly, the user 108 can interface with the business management circuitry 106 to simultaneously monitor and control one or more multiple streaming environments 110 in a scalable manner. The business management circuitry 106 can provide instructions that are applied globally across an organization (e.g., to every hotel in the hotel chain). The business management circuitry 106 can also provide instructions that are specific to a particular streaming environment 110B. In the example of FIG. 1, the user 108 is an employee of the hotel chain. In other examples, the user 108 is a different type of individual. The business management circuitry 106 is described further in connection with FIG. 8.

FIG. 2 is a block diagram of an example implementation of a streaming environment of FIG. 1. The example of FIG. 2 shows the streaming environment 110A includes MMCs 202A and 202B, . . . (collectively referred to as MMCs 202), a set top box (STB) device 204A, a laptop 204B, a smart device 204C, . . . (collectively referred to as client devices 204), a playback device 206, a local network 210. While the examples provided below refer to the streaming environment 110A, the teachings of this disclosure may be applied to any of the steaming environments 110.

The MMCs 202 are devices that provide media streams to the client devices 204 in a manner that improves streaming quality and reduces bandwidth across the local network 210. A given streaming environment 110A may contain any number of MMCs 202. In the illustrative example of FIG. 2, one or more of the MMCs 202 receives multiple requests for the same media streams (e.g., media from content provider 102A) from the client devices 204. In general, an MMC 202A makes one request and receives one media stream over the global network 104 per unique request generated from the client devices within the streaming environment 110. Upon receiving matching requests from one or more of the client devices 204, the MMC 202A sends a single request for the media stream to the content provider 102A via the global network 104 and receives a single HLS media stream.

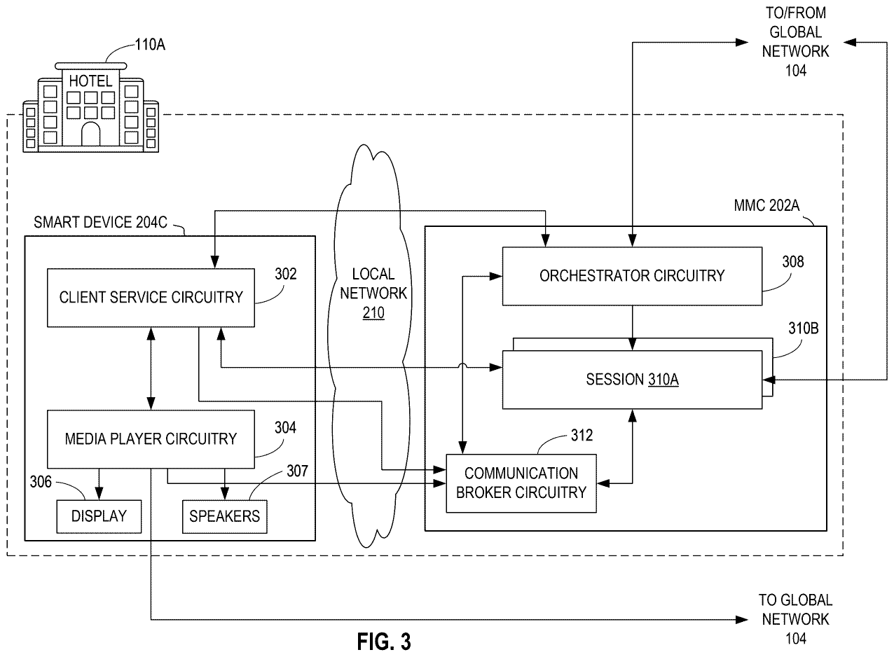

The MMC 202A transmits multiple copies of the media streams it receives to the client devices 204 that requested the media. Before the transmission, the MMC 202A re-formats one or more copies of the media stream using the DUSF protocol as described further below. Thus, the MMC 202A may simultaneously transmit one or more of a HLS unicast, and a UDP multicast, or a QAM carrying the same content. Advantageously, any client device that receives the stream data through a form of multicast reduces the bandwidth consumed by the local network 210 in comparison to the same client device having to instead use HLS unicast. The MMC 202A is described further in connection with FIG. 3.

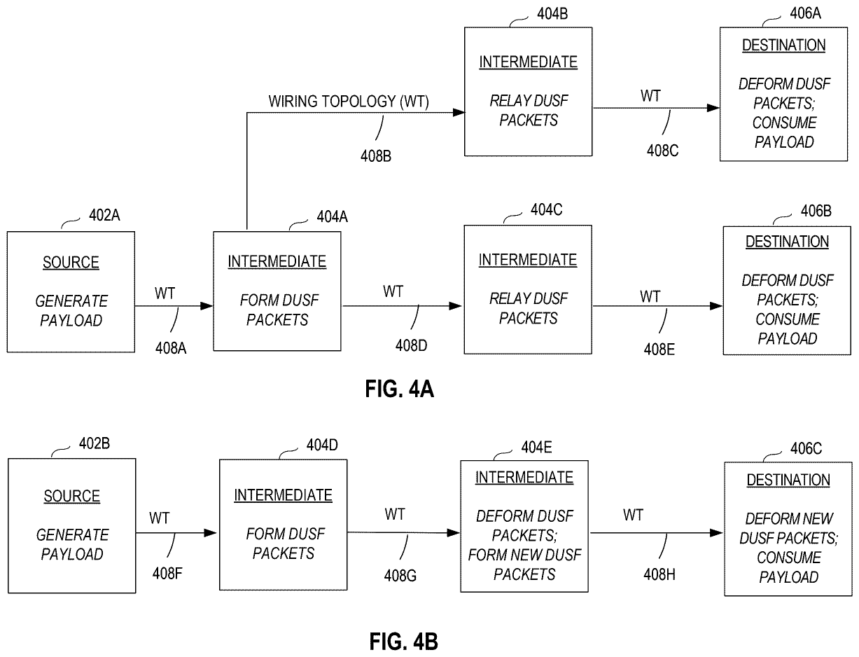

The MMC 202A may use both the local network 210 and any number of MMCs 202B, . . . , to transmit the media streams to the client devices 204. Thus, in the foregoing example, the content providers 102 are source devices, the MMCs 202 are intermediary devices, and the client devices 204 are destination devices. DUSF transmission paths between source devices, intermediary devices, and destination devices in a local network are described further below in connection with FIGS. 4A and 4B. In some examples, some or all of the functionality of an MMC 202 is implemented by an Ethernet switch device.

The local network 210 refers to infrastructure within a given streaming environment 110A that enables the client devices 204 and MMCs 202 to communicate with one another. Accordingly, the local network 210 may include hardware components such as cables, ports, routers, etc. Moreover, the local network 210 may implement any number of different writing topologies and therefore support any number of different protocols as described above.

For example, a first device in the local network 210 may connect to a second device in the local network through one or more of: a wired transmission medium using Ethernet, a wired transmission medium where the first packets are transported using Ethernet, a wireless transmission medium where the first packets are transported using Wireless Fidelity (Wi-Fi), a wired transmission medium where the second packets are transported over a coaxial cable or a wireless transmission medium where the second packets are transported over a radio frequency architecture such as satellite or over-the-air (OTA) broadcasts, etc. In some examples, the local network 210 may be referred to as a private network.

The client devices 204 are devices within the that request media streams for playback. The media streams may be in any suitable architecture, including but not limited to linear television channels and Video on Demand (VoD)/streaming content. The client devices 204 form requests for media based on user input. The client devices 204 may use any suitable form of user input, including but not limited to button presses from a remote or software application, voice commands, etc. In some examples, the client devices 204 include Internet connections to request media streams, receive media metadata, receive user interface data, receive media streams, etc. A given streaming environment 110A may include any number of client devices 204.

In some examples, one or more of the client devices 204 requests the same media stream. In such examples, the client devices 204 transmit the request to the MMC 202A, receive the corresponding media stream, and provide the resulting media data, e.g., synchronized image and audio data, to various internal or external displays. Such displays include but are not limited to the playback device 206, a laptop screen, a television screen, etc.

The client devices 204 may communicate with the MMC 202A using any suitable network communication protocol. Such protocols include but are not limited to Ethernet, COAX, Wi-Fi, etc. The client devices 204 also support one or more stream delivery protocols. Such media protocols include but are not limited to HLS unicast, UDP multicast, or QAM. A given client device 204A may be limited to a particular selection of network communication protocol(s) and stream delivery protocol(s) for any reason, including but not limited to data storage requirements, processor speed requirements, the hardware, firmware, or software on the device being outdated, the streaming environment 110A not having the infrastructure to support a given protocol, etc.

In this example, the client devices 204 and the MMCs 202 all use the DUSF protocol in conjunction with their respective network communication protocols. Thus, all media delivery within the streaming environment 110A can be centrally organized and controlled by the business management circuitry 106 irrespective of the specific wiring topology and protocol that any two devices connected to the local network 210 use to communicate. Similarly, while each of the streaming environments 110B, 110C, . . . , have their own unique combination of devices, hardware infrastructure, and wiring topologies, DUSF allows all media delivery to be centrally managed by an external source in a manner that scales irrespective of these differences. Thus, the examples described herein enable management organizations to make media delivery decisions based on their business needs rather than their hardware limitations.

In the example of FIG. 2, each of the client devices 204 can communicate with one or more of the MMCs 202 through the local network 210. In other examples, one or more of the client devices 204 are unable to communicate over the local network 210 and therefore communicate with the one or more MMCs 202 using the global network 104 instead. In such examples, communication between the client devices 204 and the MMCs 202 that occurs through the global network 104 is referred to as back-channel communication. The client devices 204 are described further in connection with FIG. 3.

FIG. 3 is a block diagram of an example implementation of a client device and an MMC of FIG. 2 to stream media. The client devices 204 and MMCs 202 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the client devices 204 and MMCs 202 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example of FIG. 3 includes the smart device 204C, the local network 210, and the MMC 202A. The example of FIG. 3 shows the smart device 204C includes client service circuitry 302, media player circuitry 304, a display 306, and speaker devices 307. The example of FIG. 3 also shows the MMC 202A includes orchestrator circuitry 308, sessions 310A, 310B, . . . (collectively referred to as sessions 310), and communication broker circuitry 312.

Within the smart device 204C, the client service circuitry 302 communicates with the MMC 202A to obtain media streams. For example, the client service circuitry 302 uses the DUSF protocol to self-register with the orchestrator circuitry 308, request a media stream from the orchestrator circuitry 308, and receive media stream data from one of the sessions 310. The use of a DUSF protocol by a destination device such as the smart device 204C is described further in connection with FIGS. 4A and 4B.

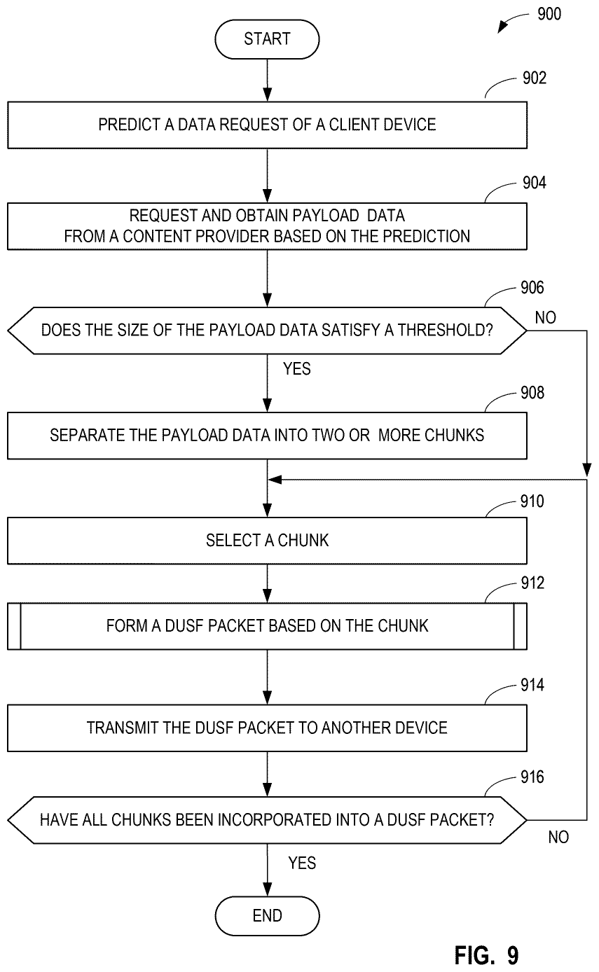

The client service circuitry 302 also uses forwards the media stream data to the media player circuitry and provides stream metrics to the communication broker circuitry 312. In this example, the stream metrics generally include metadata that describe the state of communications between the client service circuitry 302 and the MMC 202A. Accordingly, stream metrics generated by the client service circuitry 302 may include but is not limited to a description of whether any of its requests for media streams have failed, the number of media stream segments that have been received, etc. In some examples, the client service circuitry 302 is instantiated by programmable circuitry executing client service instructions and/or configured to perform operations such as those represented by the flowchart(s) of FIGS. 9-11.

The media player circuitry 304 presents the media stream data it receives from the client service circuitry 302 by providing video data to the display 306 and audio data to one or more speakers 307. The media player circuitry 304 may perform any type of reformatting or decapsulation operations necessary to convert the media stream data into an output that is interpretable by the display 306 and speakers 307. For example, the media player circuitry 304 determines individual Red, Green and Blue (RGB) values for pixels on the display 306 based on image frames within the media stream data. The media player circuitry 304 also reports stream metrics to the communication broker circuitry 312. In this example, the stream metrics generally refer to information that describes the media playback. Accordingly, stream metrics generated by the media player circuitry 304 include but are not limited to a description of whether the media player is buffering, idle, tuning between different media streams, etc.

The media player circuitry 304 also provides Digital Rights Management (DRM) data to the content providers 102 via the global network 104. Unlike the video and audio data that is requested and received through the MMC 202A, the individual client devices 204 provide DRM data to the content providers 102. In some examples, the media player circuitry 304 is instantiated by programmable circuitry executing media player instructions and/or configured to perform operations such as those represented by the flowchart(s) of FIGS. 9-11.

Within the MMC 202A, the orchestrator circuitry 308 controls the streaming activity of all client devices 204 within the streaming environment 110A, including but not limited to the smart device 204C. For example, the orchestrator circuitry 308 uses the DUSF protocol to broadcast metadata to new client devices 204 that join the streaming environment 110A to self-register. In some examples, the foregoing broadcast operations use one or more other MMCs 202B, . . . , as intermediary devices as described further in connection with FIGS. 4A and 4B.

The orchestrator circuitry 308 within the MMC 202A also determines how devices within the local network 210 use the DUSF protocol to communicate with one another. For example, the orchestrator circuitry 308 selects an indexing scheme and a compression scheme to use as described further below. The ability to select an indexing scheme and compression scheme for a DUSF protocol may be granted to only one of the MMCs 202 within a particular local network 210. In this example, the MMC 202A selects the indexing scheme and compression scheme based on instructions from the business management circuitry 106.

More generally, the orchestrator circuitry 308 within any of the MMCs 202 may determine when to form, encapsulate, forward, and/or decapsulate a DUSF packet. The orchestrator circuitry 308 determines which type of action to perform on a DUSF packet based on the contents of the DUSF packet and the structure of the DUSF transmission path as described furthers in FIGS. 4A and 4B. In some examples, the orchestrator circuitry 308 is instantiated by programmable circuitry executing orchestrator instructions and/or configured to perform operations such as those represented by the flowchart(s) of FIGS. 9-11.

The sessions 310 represent software modules that obtain media stream data from the content providers 102 and distribute the media stream data to one or more client devices 204. The sessions 310 are opened and closed by the orchestrator circuitry 308 so that there is one session open per unique media title that is currently being requested by the client devices 204. For example, suppose the set top box 204A requests a news channel stream and the laptop 204B requests a home improvement channel stream at the same time. In response, the orchestrator circuitry 308 opens session 310A and provides instructions for the session 310A to obtain and distribute news channel stream data. The orchestrator circuitry 308 also opens session 310B and provides instructions for the session 310B to obtain and distribute home improvement channel stream data. If a user then tunes the smart device 204C to the home improvement channel while the laptop 204B is still streaming the same media, the orchestrator circuitry 308 forwards the request from the smart device 204C to the session 310B instead of opening a new session. Thus, a single session 310B can support multiple client devices 204 that are simultaneously requesting data from the same media stream. The example FIG. 3 shows two active sessions 310A and 310B. More generally, the orchestrator circuitry 308 may instantiate any number of concurrently active sessions 310.

Advantageously, the sessions 310B distribute the media stream data by implementing the DUSF protocol (e.g., forming, encapsulating, forwarding, and/or decapsulating one or more DUSF packets) based on instructions from the orchestrator circuitry 308. In some examples, the sessions 310 are instantiated by programmable circuitry executing session instructions and/or configured to perform operations such as those represented by the flowchart(s) of FIGS. 9-11.

In examples where the smart device 204C and MMC 202A are connected by an Internet Protocol (IP)-based wiring topology (e.g., TCP, UDP, etc.), the communication broker circuitry 312 provides an interface to enable the exchange of data both internally between components of the MMC 202A and externally with the client devices 204. To do so, the communication broker circuitry 312 receives and forwards data to various components in FIG. 3 using a communication protocol. The communication protocol used may be any suitable machine-to-machine network protocol, including but not limited to publish/subscription protocols.

When implemented, the communication broker circuitry 312 may receive and forward any type of data to support the operations of the streaming environment 110A. For example, the client service circuitry 302 or media player circuitry 304 may send event messages to the communication broker circuitry 312 via the local network 210. The event messages may include but are not limited to information describing stream properties, client device configuration properties, whether the media stream is buffering, etc. The communication broker circuitry 312 is not implemented in examples where the smart device 204C and MMC 202A are connected by a wiring topology that is not IP-based (e.g., COAX, DVB-T, QAM).

FIGS. 4A and 4B are illustrative examples of devices implementing the DUSF protocol. FIGS. 4A and 4B include example source devices 402A, 402B (collectively referred to as source devices 402), example intermediate devices 404A, 404B, 404C, 404D, 404E (collectively referred to as intermediate devices 404), example destination devices 406A, 406B, 406C (collectively referred to as destination devices 406), and example wiring topologies 408A, 408B, 408C, 408D, 408E, 408F, 408G, 408H (collectively referred to as wiring topologies 408).

In both of FIGS. 4A and 4B, the source devices 402 refer to devices that generate payloads. As used above and herein, a payload refers to data consumed by a destination device (e.g., the destination device performs one or more operations using the payload or based on the payload). In these examples, the source devices 402 are implemented by the content providers 102 and the destination devices 406 are implemented by the client devices 204. Thus, in these examples, the payload describes a portion of a media stream (e.g., video data that describes one or more image frames and corresponding audio, metadata corresponding to said video data, etc.). In other cases, the source and/or destination devices are different, thereby causing the generated payload to contain different types of information. In a first example, the business management circuitry 106 implements a source device 402, one or more of the MMCs 202 or the client devices 204 implement destination devices, and the payloads generated by the business management circuitry 106 are firmware updates that change business logic stored within the corresponding destination devices. In another example, the smart device 204C is a source device 402, the MMC 202A is a destination device 406, and the payload is a configuration message that registers the smart device 204C, requests a particular media stream, etc. as described above in FIG. 3. More generally, the source devices 402 may be implemented by any type of device, the destination devices 406 may be implemented by any type of device, and the payload data may contain any kind of information. In some examples, the source devices 404 transmit the payload by formatting the information into one or more data packets.

The intermediate devices 404 refer to any device that receives payload data from a source device and forwards the payload data to one or more other devices. In this example, the intermediate devices 404 forwards a copy of the payload data to any device it is connected to in the local network. Thus, in FIG. 4A, the intermediate device 404A forwards the payload from the source device 402A to both the intermediate device 404B and 404C because the intermediate device 404A connects to two devices within the local network 210. The recipient(s) of the forwarded payload data may be a destination device or may be another intermediate device. In the examples of FIGS. 4A and 4B, the intermediate devices 404 are implemented by the MMCs 202. In other examples, one or more intermediate devices 404 are implemented by a different kind of device.

The source devices 402, intermediate devices 404, and destination devices 406 exchange data over the wiring topologies 408. Accordingly, the wiring topologies 408 may be implemented by Ethernet, Wi-Fi, COAX, RF Digital Video Broadcasting (DVB) architectures, etc. Moreover, a given wiring topology 408A may refer to the same wiring topology or a different wiring topology as any other wiring topology 408B, . . . , 408H.

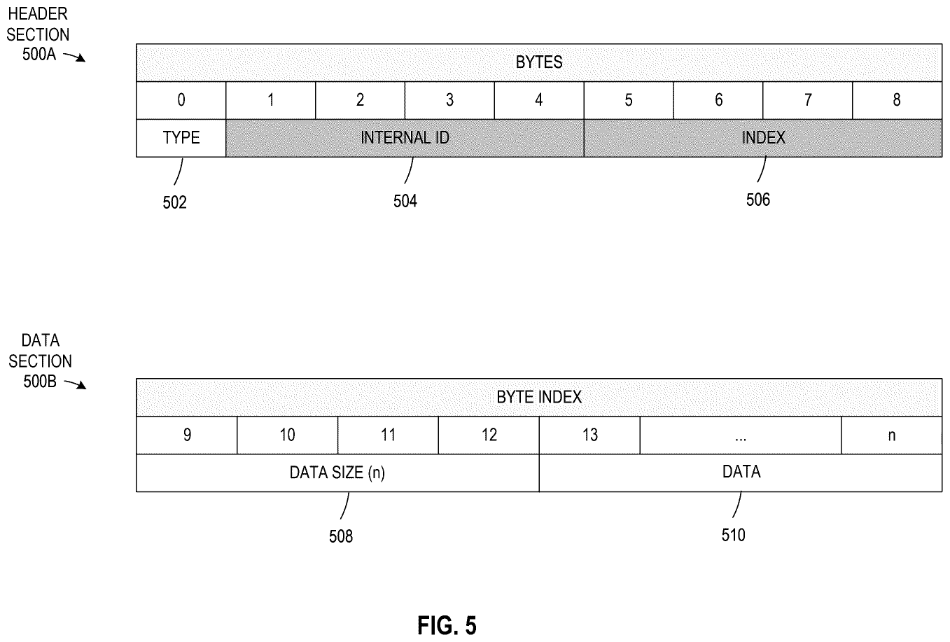

While all intermediate devices 404 ultimately forward payload data to another device as described above, the corresponding operations used to forward the payload device may be different amongst the intermediate devices 404. Similarly, some of the intermediate devices 404 may perform additional operations after receiving and before forwarding the payload data that are different from one another. For example, the first intermediate device in a transmission path (e.g., the intermediate devices 404A and 404D in FIGS. 4A and 4B, respectively) form DUSF packets using the payload data provided from the source devices 402A, 402B respectively. To form a DUSF packet, a given intermediate device 404A decapsulates any external data that the source may have encapsulated around the payload, breaks the payload data into one more chunks, and adds a DUSF header into to each chunk. A given DUSF packet therefore refers to one chunk of payload data and its corresponding DUSF header. The format of a DUSF packet is described further in connection with FIGS. 5-8 .

When forming DUSF packets, intermediate devices 404 determine how to break a payload from a source device 402 into one or more chunks based on the maximum size of a datagram within the local network. As used above and herein, a datagram refers to a self-contained unit of data transmitted using various protocols such as IP or UDP. In many examples, the datagram is 1500 bytes or smaller to avoid fragmentation over standard IP networks. Thus, in such examples, an intermediate device 404A divides a payload into enough chunks (where each chunk refers to an approximately equal amount of data) such that the total amount of data in both a given chunk and its corresponding DUSF header is less than 1500 bytes. In other examples, the maximum size of datagram within a local network is different, and the intermediate devices 404 divide the payload into multiple chunks in view of said differences.

Intermediate devices 404 may also perform encapsulation or decapsulation operations that add or remove additional headers and/or footers to the DUSF packet. For example, the intermediate devices 404B and 404C both relay (e.g., forward) DUSF packets from the intermediate device 404A to a destination device without editing the contents of the DUSF packets. However, one or both of the intermediate devices 404B, 404C may remove (e.g., decapsulate) an additional header and/or footer that already surrounded the DUSF packets when they arrived from the intermediate device 404A. One or both of the intermediate devices 404B, 404C may additionally or alternatively add (e.g., encapsulate) an additional header and/or footer on to the DUSF packet before forwarding to the respective destination device 406. In other examples, one or both of the intermediate devices 404B, 404C do not edit the header and/or footer data surrounding the DUSF packet and merely forward the exact package of data it received from the intermediate device 404A to a destination device. More generally, all of the intermediate devices 404 have the ability to (but are not required to) perform additional encapsulation and/or decapsulation operations that surround but do not edit the DUSF packet, regardless of where the intermediate device 404 is in a particular transmission path. By supporting such functionality, a DUSF packet can be transmitted across different layers throughout the Open Systems Interconnection (OSI) model and across different wiring topologies 408 within a single transmission path.

The example of FIG. 4A shows two transmission paths: a first transmission path includes data flow from source device 402A→intermediate device 404A→intermediate device 404B→destination device 4046A, while a second transmission path includes data flow from source device 402A→intermediate device 404A→intermediate device 404C→destination device 4046D. The intermediate device 404A is a part of both transmission paths because the intermediate device 404A communicates with both the intermediate device 404B and the intermediate device 404C. More generally, in this example, a given intermediate device forwards a copy of a payload to all devices it is connected to within the local network as described above. In this example, the wiring topology 408B that connects the intermediate devices 404A and 404B is different than the wiring topology 408D that connects the intermediate devices 404A, 404C. The intermediate devices 404A therefore forms a first set of DUSF packets for the intermediate device 404B and a second, different set of DUSF packets for the intermediate device 404C, even though the payload in the first send second sets of DUSF packets refer to the same information received from the source device 402A. A given intermediate device may be capable of direct communication with multiple other intermediate devices, thereby forming any number of potential transmission paths within the local network 210. Moreover, the intermediate devices 404 that form DUSF packets do so based on the specific wiring topology that the packets will be transmitted across.

In the example of FIG. 4B, the intermediate device 404E receives payload data from the source device 402B that has already been formatted into a first set of DUSF packets by the intermediate device 404D. However, the intermediate device 404E deforms the first set of DUSF packets to recover the underlying payload data and then forms a new, second set of DUSF packets. The intermediate device 404E repackages the payload data in the foregoing manner because the first set of DUSF packets are compatible with the wiring topology 408G but not the wiring topology 408H. For instance, the intermediate device 404E may perform such DUSF repackaging because the wiring topology 408G utilizes COAX and the wiring topology 408H utilizes Ethernet.

In other examples, the intermediate device 404E overcomes the differences in TMs by chaining DUSF encapsulation rather than removing and reperforming DUSF encapsulation. To perform chained encapsulation in other examples, the intermediate device 404E keeps the headers from the first set of DUSF packet and adds on an additional DUSF header that corresponds to the second set of DUSF packet. The intermediate devices 404 only a) reform new DUSF packets or b) perform chained DUSF encapsulation if the first DUSF packets does not meet the constraints of a successive physical medium. In general, the intermediate devices 404 seek to avoid such operations by forming initial DUSF packets based on a physical medium with the most constraints. In examples where the intermediate devices 404 are implemented by the MMCs 202 in FIG. 2, the MMCs 202 determine which wiring transmission within a given transmission chain has the most constraints based on instructions from the business management circuitry 106.

The concepts shown in FIG. 4A (e.g., an intermediate device capable of communicating with multiple other intermediate devices, relaying DUSF packets without editing their internal structure, etc.) are not mutually exclusive with the concepts shown in FIG. 4B (e.g., an intermediate device deforming initial DUSF packets to create new DUSF packets). A local network may contain any number of intermediate devices that each may communicate with any number of other intermediate devices, thereby forming any number of transmission paths between a source and destination.

Furthermore, a given transmission path may include any number of intermediate devices performing any number of DUSF packet formation, deformation, forwarding, encapsulation, and/or decapsulation operations.

FIG. 5 is an illustrative example of a DirecTV® Unified Stream Format (DUSF) packet described herein. FIG. 5 includes an example header section 500A and an example data section 500B. The header section 500A includes an example type field 502, an example internal ID field 504, and an example index field 506. The corresponding data section 500B of FIG. 5B includes an example data size field 508 and an example data field 510. A given DUSF packet as described above in FIGS. 4A and 4B is comprised of one header section 500A followed by one data section 500B.

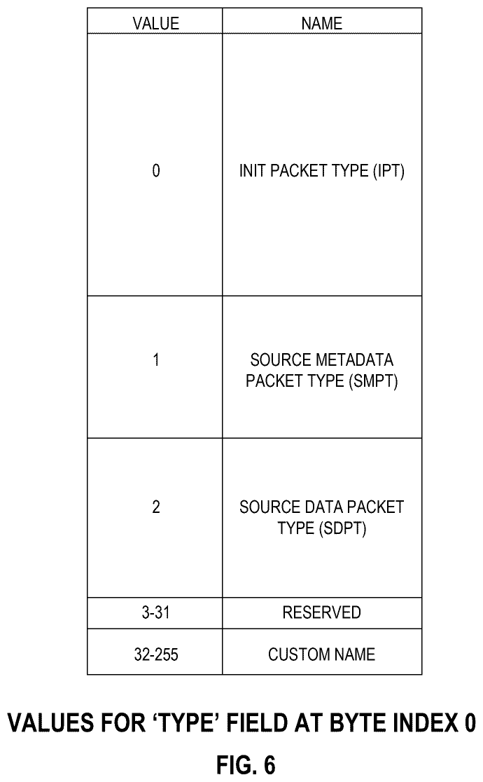

Within the header section 500A, the type field 502 helps devices determine which type (e.g., which category) of information is described in the rest of the DUSF packet. Example values that may be implemented within the type field 502 are described further in FIG. 6.

The internal ID field 504 provides a system for devices to catalog and count exchanges between one another. The internal ID field 504 is described further in connection with FIGS. 7A and 7B.

The index field 506 is used by devices to determine the correct order of DUSF packets that share a common value in the internal ID field 504. A given identification value within the internal ID field 504 may correspond to multiple DUSF packets, and each of the multiple DUSF packets has a unique value in its index field 506. In this example, values in the index field 506 increment by one each time a DUSF packet is generated (e.g., in chronological order) Thus, the index field 506 can indicate which of the multiple DUSF packets to read first, second, etc. Such information is critical in protocols where packets are not guaranteed to arrive at a receiving device in the same chronological order that a transmitting device sent the packets (e.g., UDP).

Within the data section 500B, the data size field 508 describes the number of bytes within the data field 510. In this example, DUSF packets include the data size field 508 because such information may be beneficial to deserializer operations performed by a device that deforms the DUSF packet. However, the data size field 508 is not considered part of the header section 500A because the data size field 508 is optional and not used in other DUSF packet implementations.

The data field 510 contains a chunk of the payload data from a source device. The data field 510 may be composed of any number of bytes (as shown by the field ending with a byte index of n in FIG. 5), but the size of a chunk of payload data is generally limited by the maximum size of a datagram as described above.

In the example of FIG. 5 and in examples described below, the TPYE field 502 has a length of one byte, the internal ID field 504 has a length of four bytes, the index field 506 has a length of four bytes, the data size field 508 has a length of four bytes, and the data field 510 may have any length. In other examples, one or more of the foregoing data fields have a different length. In such examples, a central management organization (e.g., the business management circuitry 106) informs all devices in the local network 210 of the different field lengths to ensure the devices can still use the DUSF protocol to communicate effectively.

FIG. 6 is a table describing example values for the TYPE field at byte index 0 of the header section of FIG. 5. In the example of FIG. 6, the type field 502 stores an unsigned integer that is one byte in length and therefore has 256 possible values.

FIG. 6 shows the value 0 in the type field 502 indicates the DUSF is categorized as an Initialization Packet Type (IPT). As used herein, a DUSF packet categorized as an IPT may be referred to simply as an IPT. An IPT contains initialization information that provides contextual information that enables devices downstream (e.g., the intermediate devices 404 and destination devices 406) to interpret subsequent DUSF packets. An IPT also has a specific structure to its data field 510 as described further in FIGS. 7A and 7B.

Advantageously, IPTs help limit the quantity of metadata sent across a network. For example, known media delivery protocols generally add a comparatively large amount of metadata (e.g., on the scale of hundreds or thousands of bytes) to each packet containing a portion of a payload because one or more of the packets may be dropped during transmission. In contrast, the DUSF includes a very minimal amount of metadata per packet (e.g., the header section 500A is 9 bytes) and puts the remaining metadata necessary to interpret the DUSF headers into a single IPT per source. The total amount of metadata using the DUSF protocol is less than the known protocols because the IPT serves as an interpretation guide. The examples described herein support this improved performance because unlike know media delivery protocols, the DUSF protocol is designed for use within a private network managed by a central entity. The central entity ensures that any intended recipient device within the controlled environment can eventually receive the IPT, thereby removing the need for the DUSF protocol to consider loss of the IPT in their design.

FIG. 6 shows the value 1 in the type field 502 indicates the DUSF packet is a Source Metadata Packet Type (SMPT). A SMPT refers to the metadata of a payload provided by a source device 402. For example, suppose a device receives payload data that describes to an entire HTTP response and divides the response into multiple DUSF packets. The DUSF packets that contain the HTTP response headers are SMPTs and therefore have a value of 1 in the type field 502.

FIG. 6 shows the value 2 in the type field 502 indicates the DUSF packet is a Source Data Packet Type (SPDT). A SPDT refers to a chunk of a payload that contains some or all of the actual information within the payload (e.g., the body portion of the payload).

FIG. 6 shows the values 3-31 of the type field 502 are reserved for future development of the DUSF protocol. Finally, values 32-255 can be customized by a management organization to name packet types that are needed in specific contexts (e.g., packet types that are unique to the specific local network controlled by the management organization).

FIGS. 7A and 7B are an example code snippet and table describing the DATA field of FIG. 5 for an IPT. FIG. 7A shows that when a DUSF is an IPT (e.g., has a TYPE value of 0 as described above), the data field 510 at byte indices 9-n is a JSON object. In these examples, the business management circuitry 106 determines the JSON object that implements the data field 510 of an IPT is compressed using GNU ZIP (GZIP). In other examples, a management organization instructs all the devices in a local network to use a different compression algorithm.

The JSON object of FIGS. 7A and 7B includes an example source identification field 702 (referred to herein as source ID field 702), the internal identification field 504, an example total count field 704, an example total count field 706, an example version major (maj) field 708, an example version minor (min) field 710, an example options field 712, an example metadata compression field 714, an example enabled field 716, and an example algorithm field 718. FIG. 7B shows the corresponding data type of each field shown in FIG. 7A.

The source ID field 702 of FIGS. 7A and 7B is a string that stores a universal unique identifier (UUID). The source ID represents uniquely a resource that has been “split” into several DUSF packets. Accordingly, any device that deforms DUSF packets (e.g., the destination devices 406 and the intermediate device 404E in FIG. 4) use the source ID field 702 to reassemble the original information provided by the source device. For example, if the payload is an HTTP request, the value of the source ID field 702 could be the output of a hash function that can only be generated if a specific Uniform Resource Link (URL) is used as an input to the function. Devices that form DUSF packets seek to populate the source ID field 702 using a technique that avoids clashes. For example, generating a UUID by executing a hashing function with a string input generally has a low probability of creating clashes. The likelihood of any two input strings clashing with one another depends on the specific hashing function used and the contents of the input strings. As used above and herein, a clash refers to a device that populates the source ID field 702 with the same value (e.g., the same UUID) for two different resources (e.g., two different URLs).

In the example of FIGS. 7A and 7B, the data field 510 of an IPT repeats the same value found in the internal ID field 504 of the header section 500A. The values in the source ID field 702 are comparatively long (e.g., a Universally Unique Identifier (UUID) is 16 bytes). Rather than including the source ID value in the header section 500A where it would be present in every DUSF packet, the protocol described herein reduces overhead by instead adding the internal ID field 504 which is comparatively shorter (e.g., 4 bytes in FIGS. 5 and 7B). Thus, the DUSF protocol establishes a 1:1 mapping between the internal ID field 504 and the source ID field 702 because the value in the source ID field 702 generally corresponds to a larger amount of data than the value in the data field 504. The DUSF protocol defines this 1:1 mapping in the data field 510 of an IPT. For example, suppose a source device (e.g. 402A) generates payload data that corresponds to a first value in the source ID field 702 for a period, then generates different payload data that corresponds to a second value in the source ID field 702. The change in source ID causes an intermediate device (e.g., 404A) downstream to form the subsequent DUSF packets using a new value for the internal ID field 502 due to the foregoing 1:1 mapping.

Advantageously, a device forming a DUSF packet generates values for the internal ID field 504 using a sequence that is also known to the destination device. The destination device can therefore change the order of DUSF packets (if necessary) based on the sequence. For example, the destination device may use the sequence that governs the internal ID field 504 to distinguish between two DUSF packets that share the same value in their index field 506. The sequence for the internal ID field 504 can have any initial value, and any algorithm or technique can be used to determine the next value, so long as both the initial value and the technique to determine the next value are known and agreed upon by all devices in a transmission path. In some examples, the initial value is nonzero and the technique to determine the next value is complex to provide enhanced security against attempts from bad actors to hijack the information. Advantageously, all devices in the local network 210 use the same sequence (e.g., use the same initial value and the same technique to determine the next value) because they are instructed to do so by the business management circuitry 106. In contrast, known protocols are unable to support such a variety of sequences because they cannot presume there is a management organization that instructs client devices within a network how to communicate with one another.

In the example of FIGS. 7A and 7B, the total count field 704 is a value that represents the total number of DUSF packets associated with a given value of the internal ID field 704. The value of the total count field 704 represents all packets that share the same internal ID, regardless of whether the type field 502 indicates the field is an IPT, SMPT, SDPT, or a different kind of DUSF packet.

In the example of FIGS. 7A and 7B, the timestamp field 706 is an 8 byte integer that represents milliseconds since epoch. The total count field 706 stores the time when the information was received by the device that forms the DUSF packet.

In the example of FIGS. 7A and 7B, the version maj field 708 is a 4 byte integer that indicates the major version of the DUSF protocol being used. Similarly, the version min field 710 is a 4 byte integer that indicates the minor version of the DUSF protocol being used. In some examples, the values in the version maj field 708 and the version min field 710 are collectively referred to as version control information.

In the example of FIGS. 7A and 7B, the options field 712 is a JSON object that hold additional information about the data in the DUSF packets associated with this value in the source ID field 702. Advantageously, a management organization that implements the DUSF protocol within a local network can add fields to the options field 712 based on their specific use case but cannot remove the fields that are default to the protocol (e.g., the fields 714, 716, and 718 shown in FIG. 5).

Within the options field 712, the metadata compression is a default JSON object that holds compression information regarding the SMPTs that share the same internal_ID as the current DUSF packet. For example, the enabled field 716 within the metadata compression object is a Boolean that specifies whether compression has been executed on the foregoing SMPTs.

Similarly, the algorithm field 718 within the metadata compression object is a string that describes the type of algorithm used to compress the SMPT when the enabled field 716 holds the logical value TRUE. In the example of FIGS. 7A and 7B, the possible values of the algorithm field 718 are “Huffman”, “LZW”, “LZMA”, “BZIP2”, and “Deflate”. In other examples, a different version of the DUSF protocol supports different compression algorithms.

FIG. 8 is an example table that describes the format of the data field 510 (e.g., bytes 13-n as shown in FIG. 5) of an SMPT. As described above, SMPTs carry the metadata portion of a payload generated by a source device (e.g., 402A in FIG. 4).

The example of FIG. 8 shows that when a source device 402A formats its payload as an HTTP Live Stream (HLS), the format of the data field 510 is a JSON object that contains the headers associated with the HTTP response. In some examples, the HTTP headers include information including but not limited to content type, content encoding, entity tags, content length, date, access control indicators, server identifiers, age, cache control indicators, etc. In other examples, the HTTP headers within the HLS JSON object include different metadata. The example of FIG. 8 also shows that SMPTs that are formatted according to Dynamic Adaptive Streaming over HTTP (DASH), or Common Media Application Format (CMAF) also have data fields formatted as JSON objects.

While an example manner of implementing the MMCs 202 and the client devices 204 of FIG. 2 is illustrated in FIG. 3, one or more of the elements, processes, and/or devices illustrated in FIG. 3 may be combined, divided, re-arranged, omitted, eliminated, and/or implemented in any other way. Further, the client service circuitry 302, the media player circuitry 304, orchestrator circuitry 308, sessions 310, communication broker circuitry 312, and/or, more generally, the example MMCs 202 and the client devices 204 of FIG. 3, may be implemented by hardware alone or by hardware in combination with software and/or firmware. Thus, for example, any of the client service circuitry 302, the media player circuitry 304, orchestrator circuitry 308, sessions 310, communication broker circuitry 312, and/or, more generally, the example MMCs 202 and the client devices 204 of FIG. 3, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the MMCs 202 and the client devices 204 of FIG. 3 may include one or more elements, processes, and/or devices in addition to, or instead of, those illustrated in FIG. 3, and/or may include more than one of any or all of the illustrated elements, processes and devices.

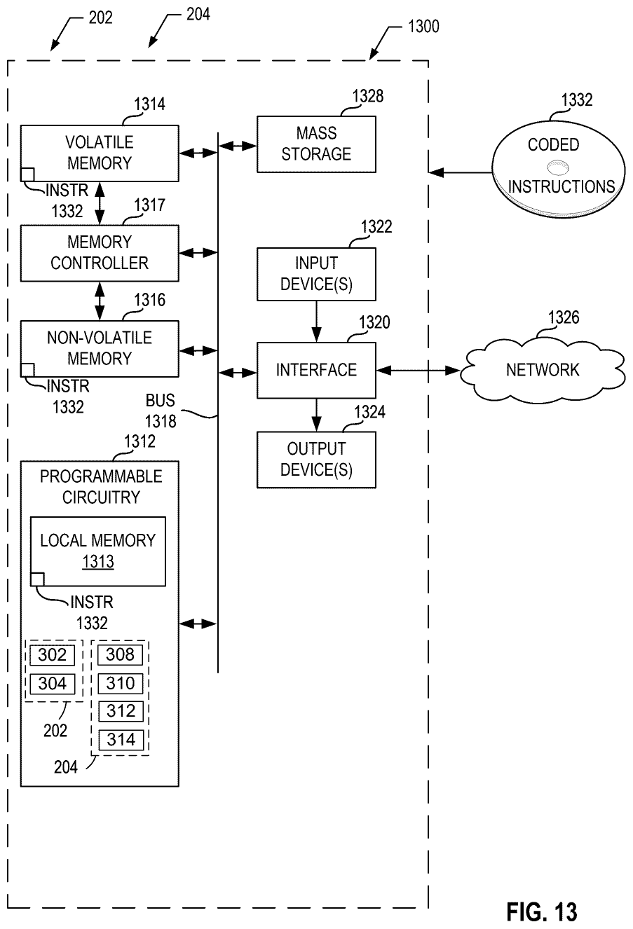

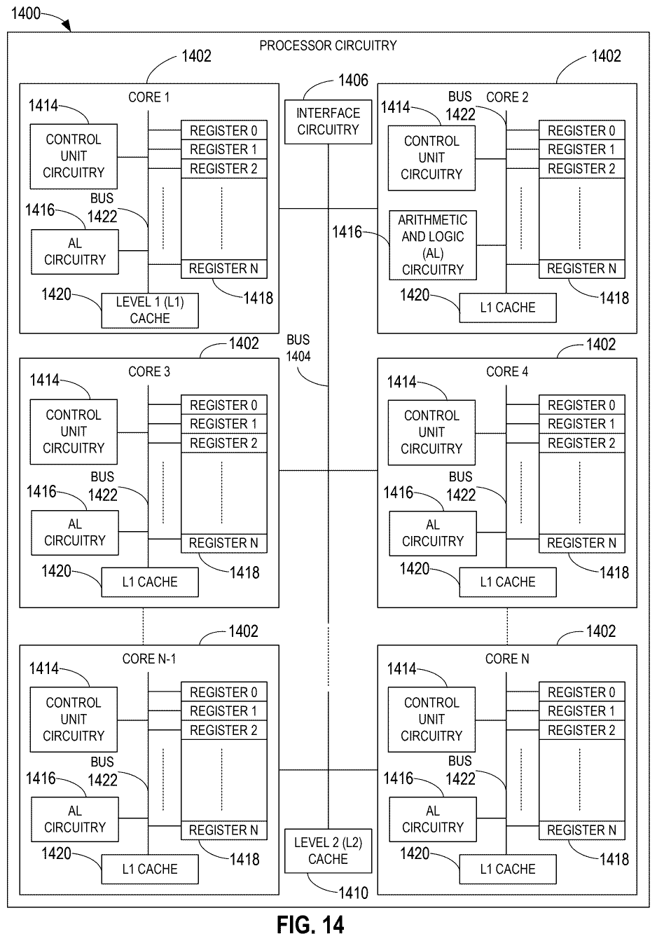

Flowchart(s) representative of example machine-readable instructions, which may be executed by programmable circuitry to implement and/or instantiate the MMCs 202 and the client devices 204 of FIG. 3 and/or representative of example operations which may be performed by programmable circuitry to implement and/or instantiate the MMCs 202 and the client devices 204 of FIG. 3, are shown in FIGS. 9-11. The machine-readable instructions may be one or more executable programs or portion(s) of one or more executable programs for execution by programmable circuitry such as the programmable circuitry 1312 shown in the example programmable circuitry platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 9-11, many other methods of implementing the example MMCs 202 and the client devices 204 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 9-11 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 9 is a flowchart representative of example machine-readable instructions and/or example operations 900 that may be executed, instantiated, and/or performed by programmable circuitry to form DUSF packets. In the example flowcharts described herein, the source devices 402 are implemented by the content providers 102 and the destination devices 406 are the client devices 204. Accordingly, the MMC 202A forms the DUSF packets in the example of FIG. 9. In other examples, a different device forms the DUSF packets.

The example machine-readable instructions and/or the example operations 900 of FIG. 9 begin when the orchestrator circuitry 308 predicts a request from a client device. (Block 902). In this example, the request is for a portion of a media stream that is provided by the content provider 102A. The orchestrator circuitry 308 predicts a request by comparing two sequences of requests from devices that are asynchronously streaming the same media as described in U.S. patent application Ser. No. 18/309,658, which is hereby incorporated by reference in its entirety.

The orchestrator circuitry 308 requests and obtains payload data from a content provider 102A based on the prediction. (Block 904). In this example, the payload data received at block 904 may include a video file for a portion of a media stream, metadata describing the title, genre, network, actors, poster art, etc. associated with the media stream, and/or other data that supports the secure transportation of such information across the global network 104. In other examples, a source device 402 generates a different payload (e.g., a firmware update). In such examples, blocks 902 and 904 are not implemented.

The orchestrator circuitry 308 determines whether the size of the payload data satisfies a threshold. (Block 906). In this example, the threshold of block 906 is satisfied if the amount of payload data is greater or equal to a threshold value (e.g., x bytes). The orchestrator circuitry 308 uses a specific threshold value based on instructions from the business management circuitry 106. In this example, the business that owns the hotel 110A sets the threshold value based on the maximum size of a datagram within the local network 210 as described above. The business then provides this threshold value (e.g., 1500 bytes) to the orchestrator circuitry 308 via the business management circuitry 106. More generally, a management organization may determine a threshold value for block 906 based on any number of factors relating to the local network.

If the size of the payload data fails to satisfy the threshold (Block 906: No), control proceeds to block 910. Alternatively, if the size of the payload data satisfies the threshold (Block 906: Yes), the orchestrator circuitry 308 separates the payload data into two or more chunks. (Block 908). Each chunk formed at block 906 corresponds to one DUSF packet as described further below. Accordingly, the orchestrator circuitry 308 determines the size of a given chunk so that the corresponding DUSF packet is at least compatible with the wiring topology that exists between the MMC 202A and the next device in the transmission chain (e.g., another one of the MMCs 202B, or one of the client devices 204). In some examples, the orchestrator circuitry 308 determines the size of a given chunk so that the corresponding DUSF packet is compatible with the most restrictive wiring topology that exists between the MMC 202A and the destination device as described above. The orchestrator circuitry 308 also divides the payload data into chunks so that each chunk, when properly formatted into the data field 510, is approximately the same size.

After block 908, or if the size of the payload data fails to satisfy the threshold (Block 906: No), the orchestrator circuitry 308 selects a chunk. (Block 910). In examples, where the payload data fails to satisfy the threshold (Block 906: No), the entire payload is considered one chunk. Accordingly, the orchestrator circuitry 308 selects the entire payload at block 910 in such examples.

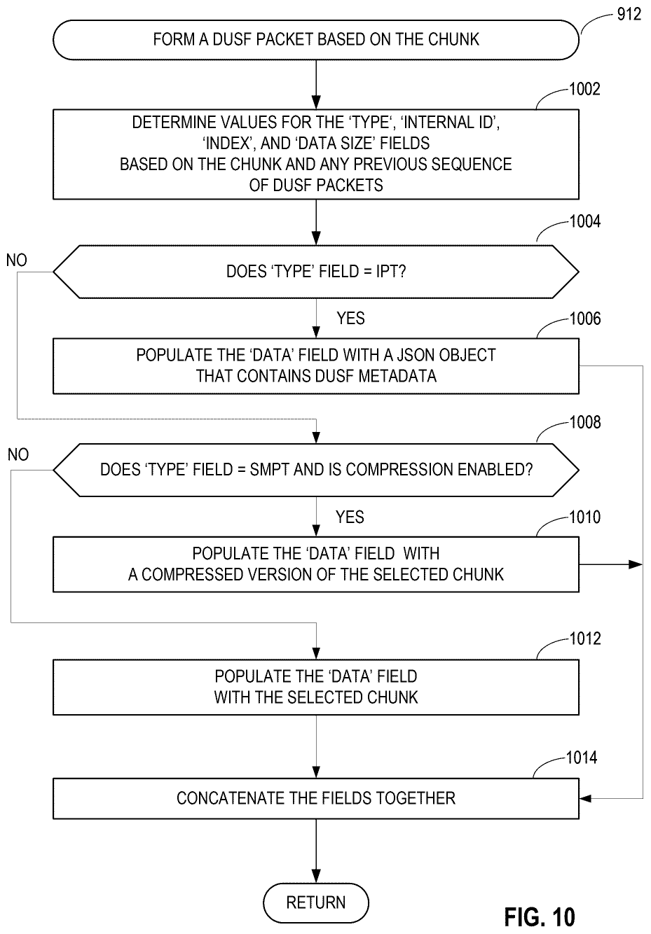

The orchestrator circuitry 308 forms a DUSF packet based on the chunk. (Block 912). Block 912 is described further in connection with FIG. 10. The orchestrator circuitry 308 then transmits the DUSF packet to another device. (Block 914). In some examples, the orchestrator circuitry 308 encapsulates the DUSF packet with additional headers or footers before transmitting the data to the other device of block 914. In such examples, the additional headers or footers provide additional metadata that support the transmission of the data across the specific wiring topology that exists between the MMC 202A and the other device of block 914. In some examples, the orchestrator circuitry 308 transmits multiple DUSF packets (each of which may optionally be encapsulated with other data) in a sequence at block 914.

The orchestrator circuitry 308 determines if all chunks have been incorporated into a DUSF packet. (Block 916). If there are any chunks that have not yet been incorporated into a DUSF packet (Block 916: No), control returns to block 910 where the orchestrator circuitry 308 selects one of said chunks. Alternatively, the machine-readable instructions and/or operations 900 end if all chunks have been incorporated into a DUSF packet. (Block 916: Yes).

FIG. 10 is a flowchart representative of example machine-readable instructions and/or example operations that may be executed, instantiated, and/or performed by example programmable circuitry to form a DUSF packet based on a chunk as described above in connection with FIG. 9. In particular, the flowchart of FIG. 10 is an example implementation of block 912 of FIG. 9.

Execution of block 912 begins when the orchestrator circuitry 308 determines values for the type field 502, internal ID field 504, index field 506, and data size field 508 based on the chunk and any previous sequence of DUSF packets. The orchestrator circuitry 308 populates such fields as described above in connection with FIG. 5. For example, the orchestrator circuitry 308 sets the type field 502 to an IPT during the first iteration of a block 1002 (e.g., when there is no previous sequence of DUSF packets that correspond to the payload of block 904). As another example, the orchestrator circuitry 308 sets the type field 502 to SMPT if a) the sequence of DUSF packets already includes an IPT and b) the selected chunk corresponds to a header within the payload. As a third example, the orchestrator circuitry 308 sets the type field 502 to SDPT if a) the sequence of DUSF packets already includes an IPT and b) the selected chunk corresponds to the body portion of the payload.

The orchestrator circuitry 308 determines whether the TYPE field selected at block 1002 indicates the current DUSF packet is an IPT. (Block 1004). If the current DUSF packet is an IPT (Block 1004: Yes), the orchestrator circuitry 308 populates the data field 510 with a JSON object that contains DUSF metadata. (Block 1006). The JSON object of block 1006 is described above in connection with FIGS. 7A and 7B. In some examples, the orchestrator circuitry 308 adds extra fields to the JSON object at block 1006 in addition to the fields shown in FIGS. 7A and 7B. Control proceeds to block 1014 after block 1006.

In examples where block 1006 is executed, the chunk selected at block 910 is not incorporated into a DUSF packet during the current iteration of block 912. Accordingly, the orchestrator circuitry 308 reselects said chunk during a subsequent iteration of block 910 so that the chunk is eventually incorporated into a DUSF packet (e.g., during a subsequent iteration of block 912).

If the current DUSF packet is not an IPT (Block 1004: No), the orchestrator circuitry 308 determines whether a) the TYPE field indicates the current DUSF packet is an SMPT and b) compression of SMPTs is enabled. (Block 1008). The decision of whether to compress SMPTs is set by a management organization and provided to the orchestrator circuitry 308 via the business management circuitry 106. The compression status of block 1008 is also recorded within the enabled field 716 of an IPT (e.g., during a previous iteration of block 912 in which block 1006 was executed).

If the current packet is an SMPT and compression is enabled (Block 1008: Yes), the orchestrator circuitry 308 populates the data field 510 with a compressed version of the chunk. (Block 1010). The orchestrator circuitry 308 compresses the chunk using a specific algorithm based on instructions from the business management circuitry 106. A description of said algorithm is also recorded within the algorithm field 718 of an IPT (e.g., during a previous iteration of block 912 in which block 1006 was executed). Control proceeds to block 1014 after block 1010.

If the current packet is not an SMPT, or if compression is disabled, (Block 1008: No), the orchestrator circuitry 308 populates the data field 510 with the selected chunk. (Block 1012). The orchestrator circuitry 308 does not perform any formatting such as compression at block 1012.

After one of blocks 1006, 1010, or 1012, the orchestrator circuitry 308 concatenates the type field 502, internal ID field 504, index field 506, data size field 508, and data field 510 together. (Block 1014). The corresponding result is a DUSF packet. Control returns to block 914 after block 1014.

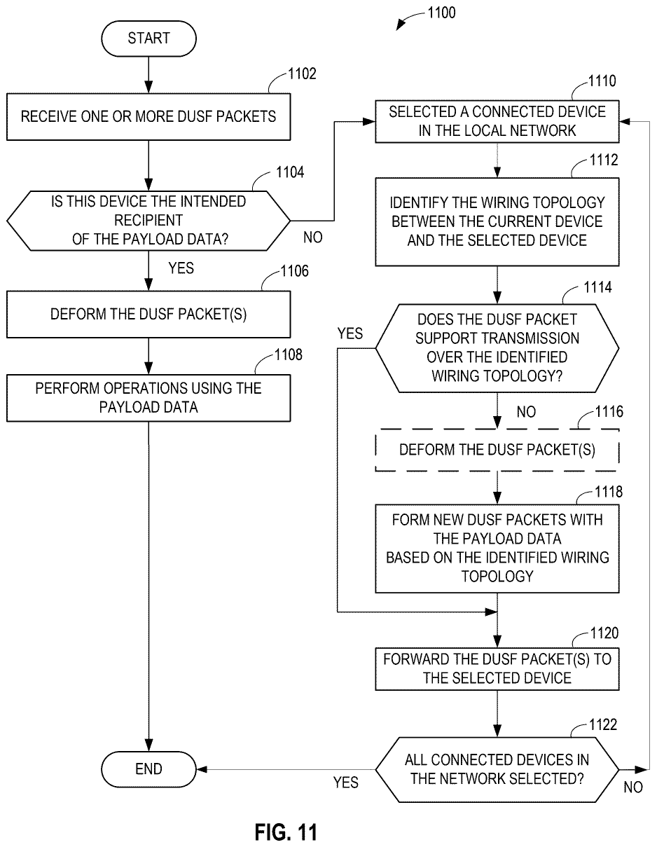

FIG. 11 is a flowchart representative of example machine-readable instructions and/or example operations that may be executed, instantiated, and/or performed by example programmable circuitry to implement a device that receives a DUSF packet. In this example, the machine-readable instructions and/or operations 1100 are implemented by one of the other MMCs 202B, . . . , or by one of the client devices 204. In other examples, the flowchart of FIG. 11 is implemented by a different kind of device within a local network that utilizes the DUSF protocol.

The machine-readable instructions and/or operations 1100 begin when a device receives one or more DUSF packets. (Block 1102). In this example, the one or more DUSF packets collectively contain a single unit of payload data provided from a source (e.g., a master manifest of an HLS stream, an HLS segment (e.g., a six second video file), etc.)

The device then determines whether it is the intended recipient of the payload data within the one or more DUSF packets. (Block 1104). The intended recipient is the destination device that consumes (e.g., performs operations with) the payload data. The device performs the determination of block 1104 based on the contents of one or more of: the DATA field 510 in the current packet, the DATA field 510 in previous packets, or a previous IPT.

If the device is the intended recipient of the payload data (Block 1104: Yes), the destination device deforms the DUSF packet(s) to recover the underlying payload data. (Block 1106). Deforming a DUSF packet refers to at least the separation of the header section 500A from the data section 500B of the DUSF packet. In some examples, deforming the DUSF packet additionally includes removing other headers and/or footers that surrounded the DUSF packet and/or decompressing the values in the data field 510.

The destination device then performs operations using the payload data. (Block 1108). In some examples, the destination device combines the DATA field of multiple DUSF packets (e.g., combines multiple chunks of the payload data) together before performing operations at block 1108. The machine-readable instructions and/or operations 1100 end after block 1108. In some examples, the operations of block 1108 are referred to as consuming the payload data.

If the device is not the intended destination of the payload data (Block 1104: No), the intermediate device selects a device it is connected to in the local network. (Block 1110). In this example, a device is considered connected to another within a local network if a) both devices are implemented within the same local network 210 and b) there is only one wiring topology that separates the two devices. Thus, in the example of FIG. 4A, the intermediate device 404A is connected to the intermediate devices 404B and 404C, the intermediate device 404B is connected to the intermediate device 404A and the destination device 406A, etc. The intermediate device may select any connected device that meets the foregoing definition at block 1110 except for the device that it received the payload data from. For example, the intermediate device 404B does not select the intermediate device 404A at block 1110 even though the two devices are connected to one another.

The intermediate device identifies the wiring topology used to forward the payload data to the selected device. (Block 1112). As described above, the wiring topology of block 1112 refers to both the physical medium across which data is transmitted and the one or more communication protocols that are used during the transmission. The intermediate device may use any suitable technique to identify the wiring topology of block 112. Such techniques may include an internal review of the hardware and software resources that implement interface circuitry within the intermediate device, a handshake/initialization procedure with the selected device, etc. In some examples, the intermediate device identifies the wiring topology at block 1112 based on instructions from the business management circuitry 106.

The intermediate device determines whether the one or more DUSF packets support transmission over the identified wiring topology. (Block 1114). A DUSF packet supports transmission over a wiring topology if the packets can be sent to the next device without editing the contents of the DUSF packets. In some examples, a DUSF packet does not support transmission over the identified wiring topology because the size of the packet is too large for one of the protocols used in the identified wired topology. In other examples, the DUSF packet does not support transmission over the identified wiring topology for different reasons.

If the DUSF packet does not support transmission over the identified wiring topology (Block 1114: No), the intermediate device optionally deforms the one or more DUSF packets. (Block 1116). In such examples, the intermediate device recovers the underlying payload data as described above in connection with block 1106.

The intermediate device forms new DUSF packets with the payload data based on the identified wiring topology. (Block 1118). In examples where the intermediate device does deform the previous DUSF packets at block 1116, forming new DUSF packet(s) at block 1116 includes dividing the payload data into new chunks that have different sizes than the old chunks of the previous DUSF packet(s). In examples where the intermediate device does not deform the previous DUSF packets at block 1116, forming new DUSF packet(s) at block 1118 does not reorganize the payload data into different sized chunks. Rather, in such examples, the intermediate device adds a new header section 500A to the previous DUSF packet(s) in a technique described above as chaining DUSF encapsulation.

After block 1118, or if the one or more DUSF packets support transmission over the identified wiring topology (Block 1114: Yes), the intermediate device forwards the one or more DUSF packets to the selected device. (Block 1120). The intermediate device may additionally add and/or remove non-DUSF headers and/or footers that surround a DUSF packet before performing the forwarding operations of block 1118.

The intermediate device determines whether all connected devices in the network (except for the device from which the intermediate device originally received the payload data) have been selected. (Block 1122). After receiving the payload data from a first device, the intermediate device forwards copies to all other connected devices within the local network 210 as described above. Accordingly, if all connected devices (except for the device from which the intermediate device originally received the payload data) within the local network have not been selected (Block 1112: No), control returns to block 1110 where another of such devices is selected. Alternatively (Block 1112: Yes), the machine-readable instructions and/or operations 1100 end.

FIG. 12 is a table that compares the DUSF protocol to known media delivery protocols. The known media delivery protocols described in FIG. 12 are File Delivery over Unidirectional Transport (FLUTE) as described in rfc6726, Wave and Equation Based Rate Control (WEBRC) as described in rfc3738, Asynchronous Layered Coding (ALC) as described in rfc5775, Layered Coding Transport (LCT) as described in rfc5651, and Forward Error Correction (FEC) as described in rfc3453. The table of FIG. 12 includes a column that describes characteristics of the example DUSF protocol described herein, and columns that describe comparable characteristics of the foregoing known protocols.

The table of FIG. 12 shows the example DUSF protocol is not specifically designed for the world wide web (e.g., the Internet). For example, the DUSF protocol has no information within it that would provide a first device access to a second device that uses a specific IP-based protocol. Accordingly, the DUSF protocol exhibits reduced overhead and dependencies on network infrastructure compared to known protocols that are designed for the Internet.

The table of FIG. 12 also shows the example DUSF protocol supports transmission over unknown network topologies while the known protocols all require knowledge of a specific topology to be used. For example, the DUSF protocol is compatible with any of the wiring topologies described above, including but not limited to IP-based protocols (TCP, UDP, etc.) that use Ethernet or Wi-Fi, OTA, COAX, DVB, etc. In contrast, known protocols only support a specific type of wiring topologies and do not work with other topologies.

The table of FIG. 12 also shows the example DUSF protocol does not have dynamic rate control. Namely, the DUSF protocol is designed to transmit data the efficient movement of data from a first device in a private network to a second device in the network. The DUSF protocol can therefore be implemented without other features that may traditionally support media data delivery (e.g., rate control, error correction, support for back-channel communications, etc.) because such functionality is organized and managed for the private network by the central management entity. Accordingly, the DUSF saves overhead in comparison to known protocols that cannot presume the support of a central management entity and therefore must use additional metadata to support such functionality.

The table of FIG. 12 also indicates the example DUSF protocol supports typed datagrams and that none of the known protocols support typed datagrams. In this example, the typed datagram is an IPT as described. Using a single control packet for each source ID value enables the subsequent data packets associated with the source ID value to include a comparatively low amount of metadata and lowers the total amount of metadata as described above. Moreover, the DUSF can implement typed datagrams such as the IPT because the management entity guarantees the typed datagram will eventually reach its destination within the controlled environment of the private network. Similarly known protocols cannot implement typed datagrams because they cannot guarantee such specialized packets will reach their destination.

The table of FIG. 12 also indicates the example DUSF protocol can include error correction. For example, the header section 500A can be expanded to include redundant parity bits that allow devices to perform Forward Error Correction (FEC) using only the DUSF packets. However the DUSF protocol is not required to support error correction, the protocol does not include such support in many examples, because the functionality is provided elsewhere by the central management entity as described above.

The foregoing features of the DUSF protocol enable it to exhibit the lowest bandwidth overhead (e.g., 9 bytes as shown in FIG. 5) compared to the known protocols (which vary on the scale of hundreds or thousands of bytes). The foregoing features also enable the DUF protocol to require the lowest operational complexity (e.g., fewer compute resources and operations are required to form or deform a DUSF packet) compared to known protocols. Accordingly, the example DUSF protocol is more efficient and scalable than known protocols in the context of private networks managed by a central entity.

FIG. 13 is a block diagram of an example programmable circuitry platform 1300 structured to execute and/or instantiate the example machine-readable instructions and/or the example operations of FIGS. 9-11 to implement the MMCs 202 or the client devices 204 of FIG. 2. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, VPUs, DSPs, and/or microcontrollers from any desired family or manufacturer. The programmable circuitry 1312 may be implemented by one or more semiconductor based (e.g., silicon based) devices. In this example, the programmable circuitry 1312 implements one or more of the client service circuitry 302, the media player circuitry 304, the orchestrator circuitry 308, the sessions 310, and the communication broker circuitry 312.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1332, which may be implemented by the machine-readable instructions of FIGS. 9-11, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 9-11 to effectively instantiate the circuitry of FIG. 2 as logic circuits to perform operations corresponding to those machine-readable instructions. In some such examples, the circuitry of FIG. 2 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine-readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine-readable instructions and/or operations represented by the flowcharts of FIGS. 9-11.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more devices by example interface circuitry 1406. The cores 1402 may output data, instructions, and/or signals to the one or more devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

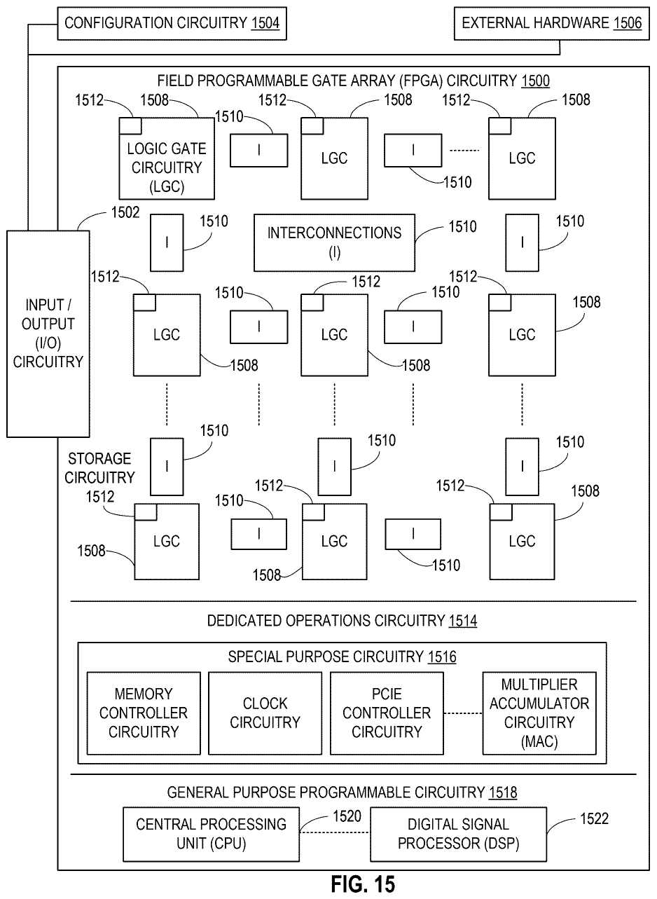

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine-readable instructions. However, once configured, the FPGA circuitry 1500 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine-readable instructions represented by the flowchart(s) of FIGS. 9-11 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 9-11 . In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-11 . As such, the FPGA circuitry 1500 may be configured and/or structured to effectively instantiate some or all of the operations/functions corresponding to the machine-readable instructions of the flowchart(s) of FIGS. 9-11 as dedicated logic circuits to perform the operations/functions corresponding to those software instructions in a dedicated manner analogous to an ASIC. Therefore, the FPGA circuitry 1500 may perform the operations/functions corresponding to the some or all of the machine-readable instructions of FIGS. 9-11 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine-readable instructions of FIGS. 9-11 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine-readable instructions represented by the flowchart(s) of FIG. 9-11 to perform first operation(s)/function(s), the FPGA circuitry 1500 of FIG. 15 may be configured and/or structured to perform second operation(s)/function(s) corresponding to a second portion of the machine-readable instructions represented by the flowcharts of FIGS. 9-11, and/or an ASIC may be configured and/or structured to perform third operation(s)/function(s) corresponding to a third portion of the machine-readable instructions represented by the flowcharts of FIGS. 9-11.

It should be understood that some or all of the circuitry of FIG. 2 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1400 of FIG. 14 may execute machine-readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIG. 2 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

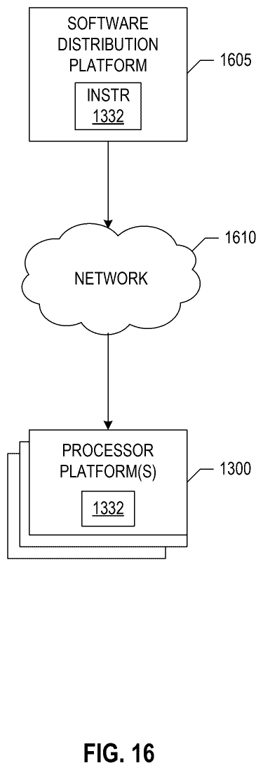

A block diagram illustrating an example software distribution platform 1605 to distribute software such as the example machine-readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine-readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine-readable instructions 1332, which may correspond to the example machine-readable instructions of FIGS. 9-11, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1332 from the software distribution platform 1605. For example, the software, which may correspond to the example machine-readable instructions of FIGS. 9-11, may be downloaded to the example programmable circuitry platform 1300, which is to execute the machine-readable instructions 1332 to implement the MMCs 202 and/or the client devices 204. In some examples, one or more servers of the software distribution platform 1605 periodically offer, transmit, and/or force updates to the software (e.g., the example machine-readable instructions 1332 of FIG. 13) to ensure improvements, patches, updates, etc., are distributed and applied to the software at the end user devices. Although referred to as software above, the distributed “software”could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B.

As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” “fourth,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third. ” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that protocol is infrastructure agnostic (and therefore not dependent on a specific wiring topology) but still achieves high efficiency OTT video delivery. Disclosed systems, apparatus, articles of manufacture, and methods improve the efficiency of using a computing device by using a central management entity that predetermines how DUSF packets are interpreted (e.g., when compression is used, which algorithms are used for compression, which starting value is used in the sequence for the internal ID field 504, which algorithm is used to determine the next value in the sequence, etc.). The central management entity also ensures that typed datagrams reach their destination within a controlled, private network and can provide other functionality such as dynamic rate control, error correction, etc., such that the DUSF packets have minimal overhead and support scalable and efficient data delivery. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture for a unified stream format are disclosed herein. Further examples and combinations thereof include the following.

Example 1 includes an apparatus comprising interface circuitry, machine-readable instructions, and programmable circuitry within a network to at least one of instantiate or execute the machine-readable instructions to obtain first packets from a first device within the network, the first packets structured according to a formatting protocol, the first device and the apparatus connected to one another with a wiring topology that includes the Internet Protocol, a given packet within the first packets including a header section and a data section, form second packets that are also structured according to the formatting protocol, the second packets having the same data sections but different header sections than the first packets, and transmit the second packets to a second device within the network, the second device and the apparatus connected to one another using a wiring topology that does not include the Internet Protocol.

Example 2 includes the apparatus of example 1, wherein the wiring topology that includes the Internet Protocol also includes a wired transmission medium where the first packets are transported using Ethernet, or a wireless transmission medium where the first packets are transported using Wireless Fidelity (Wi-Fi).

Example 3 includes the apparatus of one or more of examples 1-2, wherein the wiring topology that does not include the Internet Protocol does include a wired transmission medium where the second packets are transported over a coaxial cable, or a wireless transmission medium where the second packets are transported over a radio frequency architecture such as satellite or over-the-air (OTA) broadcasts.

Example 4 includes the apparatus of one or more of examples 1-3, wherein a header section from the first packets or the second packets includes a type field, an internal identification field, and an index field.

Example 5 includes the apparatus of one or more of examples 1-4, wherein to form the second packets according to the formatting protocol, the programmable circuitry is to organize the data sections of the first packets into a metadata portion and a body portion, form one or more of the second packets by including some or all of the metadata portion in the data section and a first value in the type field, and form one or more of the second packets by including some or all of the body portion in the data section and a second value in the type field.

Example 6 includes the apparatus of one or more of examples 1-5, wherein the programmable circuitry is to form one of the second packets by including a third value in the type field, the third value to indicate the one of the second packets is categorized as an initialization packet type (IPT), and transmit the second packet categorized as an IPT before transmitting the one or more second packets containing the metadata portion or the one or more second packets containing the body portion.

Example 7 includes the apparatus of one or more of examples 1-6, wherein the second device implements the formatting protocol by interpreting the second packets containing the metadata portion or the body portion based on the second packet categorized as an IPT.

Example 8 includes the apparatus of one or more of examples 1-7, wherein the data section of the second packet categorized as an IPT describes a source identification field associated with the identification field, a count of a total number of the second packets, a timestamp, version control information associated with the formatting protocol, and compression information about the metadata portion of the second packets.

Example 9 includes the apparatus of one or more of examples 1-8, wherein the programmable circuitry is to set, based on the formatting protocol including a 1 1 mapping between the source identification field and the internal identification field, the internal identification field for all the second packets to the same value, and the source identification field corresponds to a larger amount of data than the internal identification field.

Example 10 includes the apparatus of one or more of examples 1-9, wherein the data section of the second packet categorized as an IPT is formatted as a JSON object.

Example 11 includes the apparatus of one or more of examples 1-10, wherein the programmable circuitry is to determine how many of the second packets to form based on a maximum size of a datagram within the network.

Example 12 includes the apparatus of one or more of examples 1-11, wherein the network includes a third device connected to the apparatus with the wiring topology that includes the Internet Protocol and a fourth device connected to the apparatus with the wiring topology that does not include the Internet Protocol, the programmable circuitry is to forward the first packets to the third device, and multicast the second packets to both the second device and the fourth device.

Example 13 includes a non-transitory machine-readable storage medium comprising instructions to cause programmable circuitry within a network to at least obtain first packets from a first device within the network, the first packets structured according to a formatting protocol, the first device and the programmable circuitry connected to one another with a wiring topology that includes the Internet Protocol, a given packet within the first packets including a header section and a data section, form second packets that are also structured according to the formatting protocol, the second packets having the same data sections but different header sections than the first packets, and transmit the second packets to a second device within the network, the second device and the apparatus connected to one another using a wiring topology that does not include the Internet Protocol.

Example 14 includes the non-transitory machine-readable storage medium of example 13, wherein the wiring topology that includes the Internet Protocol also includes a wired transmission medium where the first packets are transported using Ethernet, or a wireless transmission medium where the first packets are transported using Wireless Fidelity (Wi-Fi).

Example 15 includes the non-transitory machine-readable storage medium of one or more of examples 13-14, wherein the wiring topology that does not include the Internet Protocol does include a wired transmission medium where the second packets are transported over a coaxial cable, or a wireless transmission medium where the second packets are transported over a radio frequency architecture such as satellite or over-the-air (OTA) broadcasts.

Example 16 includes the non-transitory machine-readable storage medium of one or more of examples 13-15, wherein a header section from the first packets or the second packets includes a type field, an internal identification field, and an index field.

Example 17 includes the non-transitory machine-readable storage medium of one or more of examples 13-16, wherein to form the second packets according to the formatting protocol, the programmable circuitry is to organize the data sections of the first packets into a metadata portion and a body portion, form one or more of the second packets by including some or all of the metadata portion in the data section and a first value in the type field, and form one or more of the second packets by including some or all of the body portion in the data section and a second value in the type field.

Example 18 includes the non-transitory machine-readable storage medium of one or more of examples 13-17, wherein the programmable circuitry is to form one of the second packets by including a third value in the type field, the third value to indicate the one of the second packets is categorized as an initialization packet type (IPT), and transmit the second packet categorized as an IPT before transmitting the one or more second packets containing the metadata portion or the one or more second packets containing the body portion.

Example 19 includes the non-transitory machine-readable storage medium of one or more of examples 13-18, wherein the second device implements the formatting protocol by interpreting the second packets containing the metadata portion or the body portion based on the second packet categorized as an IPT.

Example 20 includes the non-transitory machine-readable storage medium of one or more of examples 13-19, wherein the data section of the second packet categorized as an IPT describes a source identification field associated with the identification field, a count of a total number of the second packets, a timestamp, version control information associated with the formatting protocol, and compression information about the metadata portion of the second packets.

Example 21 includes the non-transitory machine-readable storage medium of one or more of examples 13-20, wherein based on a 1 1 mapping between the source identification field and the internal identification field, the programmable circuitry is to form the second packets according to the formatting protocol by including the same value in the internal identification field for all the second packets, and the source identification field corresponds to a larger amount of data than the internal identification field.

Example 22 includes the non-transitory machine-readable storage medium of one or more of examples 13-21, wherein the data section of the IPT is formatted as a JSON object.

Example 23 includes the non-transitory machine-readable storage medium of one or more of examples 13-22, wherein the programmable circuitry is to determine how many of the second packets to form based on a maximum size of a datagram within the network.

Example 24 includes the non-transitory machine-readable storage medium of one or more of examples 13-23, wherein the network includes a third device connected to the programmable circuitry with the wiring topology that includes the Internet Protocol and a fourth device connected to the programmable circuitry with the wiring topology that does not include the Internet Protocol, the programmable circuitry is to forward the first packets to the third device, and multicast the second packets to both the second device and the fourth device.

Example 25 includes a method comprising obtaining, with programmable circuitry within a network, first packets from a first device within the network, the first packets structured according to a formatting protocol, the first device and the apparatus connected to one another with a wiring topology that includes the Internet Protocol, a given packet within the first packets including a header section and a data section, forming, with the programmable circuitry, second packets that are also structured according to the formatting protocol, the second packets having the same data sections but different header sections than the first packets, and transmitting, with the programmable circuitry, the second packets to a second device within the network, the second device and the apparatus connected to one another using a wiring topology that does not include the Internet Protocol.

Example 26 includes the method of example 25, including transmitting, with the first device, the first packets to the programmable circuitry over a wired transmission medium using an Ethernet standard, or transmitting, with the first device, the first packets to the programmable circuitry a wireless transmission medium using a Wireless Fidelity (Wi-Fi) standard.

Example 27 includes the method of one or more of examples 25-26, including transmitting, with the programmable circuitry, the second packets to the second device over a wired transmission medium using a coaxial cable, or transmitting, with the programmable circuitry, the second packets to the second device over a wireless transmission medium using a radio frequency architecture such as satellite or over-the-air (OTA) broadcasts.

Example 28 includes the method of one or more of examples 25-27, wherein a header section from the first packets or the second packets includes a type field, an internal identification field, and an index field.

Example 29 includes the method of one or more of examples 25-28, wherein forming the second packets according to the formatting protocol includes organizing the data sections of the first packets into a metadata portion and a body portion, forming one or more of the second packets by including some or all of the metadata portion in the data section and a first value in the type field, and forming one or more of the second packets by including some or all of the body portion in the data section and a second value in the type field.

Example 30 includes the method of one or more of examples 25-29, wherein forming one of the second packets by including a third value in the type field, the third value to indicate the one of the second packets is categorized as an initialization packet type (IPT), and transmitting the second packet categorized as an IPT before transmitting the one or more second packets containing the metadata portion or the one or more second packets containing the body portion.

Example 31 includes the method of one or more of examples 25-30, including implementing, with the device, the formatting protocol by interpreting the second packets containing the metadata portion or the body portion based on the second packet categorized as an IPT.

Example 32 includes the method of one or more of examples 25-31, wherein the data section of the second packet categorized as an IPT describes a source identification field associated with the identification field, a count of a total number of the second packets, a timestamp, version control information associated with the formatting protocol, and compression information about the metadata portion of the second packets.

Example 33 includes the method of one or more of examples 25-32, wherein the method includes setting, based on the formatting protocol including a 1 1 mapping between the source identification field and the internal identification field, the internal identification field for all the second packets to the same value, and the source identification field corresponds to a larger amount of data than the internal identification field.

Example 34 includes the method of one or more of examples 25-33, further including formatting the data section of the second packet categorized as an IPT as a JSON object.

Example 35 includes the method of one or more of examples 25-34, including determine how many of the second packets to form based on a maximum size of a datagram within the network.

Example 36 includes the method of one or more of examples 25-35, wherein the network includes a third device connected to the programmable circuitry with the wiring topology that includes the Internet Protocol and a fourth device connected to the programmable circuitry with the wiring topology that does not include the Internet Protocol, the method includes forwarding, with the programmable circuitry, the first packets to the third device, and multicasting, with the programmable circuitry, the second packets to both the second device and the fourth device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry;
machine-readable instructions; and
programmable circuitry within a network to at least one of instantiate or execute the machine-readable instructions to:
obtain first packets from a first device within the network, the first packets structured according to a formatting protocol, the first device and the apparatus connected to one another with a wiring topology that includes an Internet Protocol, a given packet within the first packets including a header section and a data section;
form second packets that are also structured according to the formatting protocol, the second packets having the same data sections but different header sections than the first packets; and
transmit the second packets to a second device within the network, the second device and the apparatus connected to one another using a wiring topology that does not include the Internet Protocol.

2. The apparatus of claim 1, wherein the wiring topology that includes the Internet Protocol also includes:
a wired transmission medium where the first packets are transported using Ethernet; or
a wireless transmission medium where the first packets are transported using Wireless Fidelity (Wi-Fi).

3. The apparatus of claim 1, wherein the wiring topology that does not include the Internet Protocol does include:
a wired transmission medium where the second packets are transported over a coaxial cable; or
a wireless transmission medium where the second packets are transported over a radio frequency architecture such as satellite or over-the-air (OTA) broadcasts.

4. The apparatus of claim 1, wherein a header section from the first packets or the second packets includes a type field, an internal identification field, and an index field.

5. The apparatus of claim 4, wherein to form the second packets according to the formatting protocol, the programmable circuitry is to:
organize the data sections of the first packets into a metadata portion and a body portion;
form one or more of the second packets by including some or all of the metadata portion in the data section and a first value in the type field; and
form one or more of the second packets by including some or all of the body portion in the data section and a second value in the type field.

6. The apparatus of claim 5, wherein the programmable circuitry is to:
form one of the second packets by including a third value in the type field, the third value to indicate the one of the second packets is categorized as an initialization packet type (IPT); and
transmit the second packet categorized as an IPT before transmitting the one or more second packets containing the metadata portion or the one or more second packets containing the body portion.

7. The apparatus of claim 6, wherein the second device implements the formatting protocol by interpreting the second packets containing the metadata portion or the body portion based on the second packet categorized as an IPT.

8. The apparatus of claim 6, wherein the data section of the second packet categorized as an IPT describes a source identification field associated with the identification field, a count of a total number of the second packets, a timestamp, version control information associated with the formatting protocol, and compression information about the metadata portion of the second packets.

9. The apparatus of claim 8, wherein:
the programmable circuitry is to set, based on the formatting protocol including a 1:1 mapping between the source identification field and the internal identification field, the internal identification field for all the second packets to the same value; and
the source identification field corresponds to a larger amount of data than the internal identification field.

10. The apparatus of claim 6, wherein the data section of the second packet categorized as an IPT is formatted as a JSON object.

11. The apparatus of claim 1, wherein the programmable circuitry is to determine how many of the second packets to form based on a maximum size of a datagram within the network.

12. The apparatus of claim 1, wherein:
the network includes a third device connected to the apparatus with the wiring topology that includes the Internet Protocol and a fourth device connected to the apparatus with the wiring topology that does not include the Internet Protocol;
the programmable circuitry is to:
forward the first packets to the third device; and
multicast the second packets to both the second device and the fourth device.

13. A non-transitory machine-readable storage medium comprising instructions to cause programmable circuitry within a network to at least:
obtain first packets from a first device within the network, the first packets structured according to a formatting protocol, the first device and the programmable circuitry connected to one another with a wiring topology that includes the Internet Protocol, a given packet within the first packets including a header section and a data section;
form second packets that are also structured according to the formatting protocol, the second packets having the same data sections but different header sections than the first packets; and
transmit the second packets to a second device within the network, the second device and the apparatus connected to one another using a wiring topology that does not include the Internet Protocol.

14. The non-transitory machine-readable storage medium of claim 13, wherein the wiring topology that includes the Internet Protocol also includes:
a wired transmission medium where the first packets are transported using Ethernet; or
a wireless transmission medium where the first packets are transported using Wireless Fidelity (Wi-Fi).

15. The non-transitory machine-readable storage medium of claim 13, wherein the wiring topology that does not include the Internet Protocol does include:
a wired transmission medium where the second packets are transported over a coaxial cable; or
a wireless transmission medium where the second packets are transported over a radio frequency architecture such as satellite or over-the-air (OTA) broadcasts.

16. The non-transitory machine-readable storage medium of claim 13, wherein a header section from the first packets or the second packets includes a type field, an internal identification field, and an index field.

17.-24. (canceled)

25. A method comprising:
obtaining, with programmable circuitry within a network, first packets from a first device within the network, the first packets structured according to a formatting protocol, the first device and the apparatus connected to one another with a wiring topology that includes the Internet Protocol, a given packet within the first packets including a header section and a data section;
forming, with the programmable circuitry, second packets that are also structured according to the formatting protocol, the second packets having the same data sections but different header sections than the first packets; and
transmitting, with the programmable circuitry, the second packets to a second device within the network, the second device and the apparatus connected to one another using a wiring topology that does not include the Internet Protocol.

26. The method of claim 25, including:
transmitting, with the first device, the first packets to the programmable circuitry over a wired transmission medium using an Ethernet standard; or
transmitting, with the first device, the first packets to the programmable circuitry a wireless transmission medium using a Wireless Fidelity (Wi-Fi) standard.

27. The method of claim 25, including:
transmitting, with the programmable circuitry, the second packets to the second device over a wired transmission medium using a coaxial cable; or
transmitting, with the programmable circuitry, the second packets to the second device over a wireless transmission medium using a radio frequency architecture such as satellite or over-the-air (OTA) broadcasts.

28.-36. (canceled)

36. The method of claim 25, wherein:
the network includes a third device connected to the programmable circuitry with the wiring topology that includes the Internet Protocol and a fourth device connected to the programmable circuitry with the wiring topology that does not include the Internet Protocol;
the method includes:
forwarding, with the programmable circuitry, the first packets to the third device; and
multicasting, with the programmable circuitry, the second packets to both the second device and the fourth device.
